(19) United States
(12) Patent Application Publication
(10) Pub. No.: US 2012/0052431 A1
(43) Pub. Date: Mar. 1, 2012

(54) TONER FOR DEVELOPING LATENT ELECTROSTATIC IMAGES, DEVELOPER, DEVELOPER CONTAINER HOUSING DEVELOPER THEREIN, PROCESS CARTRIDGE, IMAGE FORMING APPARATUS AND IMAGE FORMING METHOD

(76) Inventors: Mamoru HOZUMI, Miyagi (JP); Tsuyoshi Sugimoto, Shizuoka (JP); Naohiro Watanabe, Shizuoka (JP); Tomoyuki Satoh, Kanagawa (JP); Shinya Hanatani, Shizuoka (JP); Osamu Uchinokura, Shizuoka (JP)

(21) Appl. No.: 13/208,941

(22) Filed: Aug. 12, 2011

(30) Foreign Application Priority Data
Aug. 27, 2010 (JP) 2010-190272

(51) Int. Cl. G03G 9/00; G03G 15/08

(52) U.S. Cl. 430/105; 399/252; 430/111.4; 430/109.1; 430/137.2; 430/137.14

(57) ABSTRACT

To provide a toner, containing: a crystalline polyester resin; and a non-crystalline polyester resin, wherein the crystalline polyester resin has a melting point of 60° C. to 80° C., and wherein the toner satisfies the relationship represented by the following formula: (W1−W1′)/W1<0.50, where W1 is a temperature width at a 1/3 height of a height of an endothermic peak of the crystalline polyester resin at the time of an initial temperature elevation on a DSC curve of the toner as measured by differential scanning calorimetry, and W1′ is a temperature width at a 1/3 height of a height of an endothermic peak of the crystalline polyester resin after the toner has been heated at 50° C. for 24 hours.

### BACKGROUND OF THE INVENTION

1. Field of the Invention

The present invention relates to a toner for developing latent electrostatic images in electrophotography, electrostatic recording, electrostatic printing, or the like, as well as a developer using the toner, a developer container housing the developer therein, a process cartridge, an image forming apparatus and image forming method using the toner.

2. Description of the Background

Conventionally, electric latent images or magnetic latent images are made visible with a toner in electrophotographic devices, electrostatic recording devices, and the like. In the electrophotography, for example, after forming an electrostatic image (a latent image) on a photoconductor, the latent image is developed with a toner to form a toner image. The toner image is generally transferred to a recording medium such as paper, and then fixed thereon by heating or other methods. The toner used for developing latent electrostatic images is generally consisted of colored particles in each of which a colorant, a charge controlling agent, and other additives are contained in a binder resin.

As a fixing method in a dry developing system, a heat roller method is commonly known because of its energy efficiency. Recently, there has been a trend for reducing thermal energy applied to a toner during fixing to save energy which has been achieved with lowering fixing temperature of the toner. In International Energy Agency (IEA) Demand-Side Management (DSM) program of 1999, there is a technology demanding project for photocopying machines of next generation, and demanded specifications are disclosed. Photocopying machines of 30 cpm or more are demanded to have a stand-by time of 10 seconds or shorter, and power consumption of 10 W to 30 W (varies depending on the printing speed) during the stand-by, and to achieve significant energy saving compared to the conventional photocopying machines. As one of the methods to achieve these demands, a method of improving thermal response of a toner by reducing a thermal capacity of a fixing member such as a heat roller has been considered, but this method does not provide fully satisfactory results.

In order to achieve the demands mentioned above and shorten the stand-by time, it is considered that reduction of fusion offset temperature of the toner and reduction of fixing temperature during the use of the toner are essential technical subject to be achieved. To achieve such low temperature fixing, use of a polyester resin, which has excellent low temperature fixing ability and relatively desirable heat resistant storage stability, has been attempted as a replacement of a styrene-acryl resin that has been conventionally widely used.

As the fixing system in the electrophotography, a method for fixing by pressing a heat roller directly against a toner image on a recording medium, namely, a heat roller fixing system, has been widely used as it has excellent heat efficiency, is capable of achieving down sizing of a device for use, and has desirable energy efficiency. As mentioned above, reduction in consumption energy of the heat roller used for fixing has been demanded from the environmental awareness, that is, energy saving.

Recently, improvements of fixing devices have been progressed, and as a result, thermal energy efficiency is enhanced by reducing a thickness of a roller provided at the side of the plane supporting a toner image, and a significant reduction of the stand-by time is possible. Since the specific heat capacity is small, however, a temperature difference between the area where the recording medium has been passed, and the area where the recording medium has not been passed, which causes toner depositions on the fixing roller. Therefore, after the fixing roller is rotated once, the toner is deposited on a non-imaging part of the recording medium, i.e. hot offset occurs. Therefore, demands for the toner to achieve hot offset resistance, as well as low temperature fixing ability, have been stricter.

Moreover, production methods of a toner used for developing latent electrostatic images are roughly classified into a pulverization method and a polymerization method. In the pulverization method, a toner is produced by melting and mixing a colorant, a charge controlling agent, an offset inhibitor, and the like into a thermoplastic resin to uniformly disperse these components in the thermoplastic resin to form a toner composition, pulverizing the toner composition, and classifying the pulverized product. Therefore, the toner having relatively excellent properties can be produced, but there are restrictions in the selection of materials for use. Specifically, the toner composition obtained through melt blending needs to be the one which can be pulverized and classified by economically usable devices. For this reason, the toner composition obtained through melt blending has to be sufficiently frail. Since the toner composition is frail, the particle size distribution tends to be wide when the toner composition is pulverized, and to provide copied images having excellent resolution and tone, for example, fine particles having diameters of 4 μm or smaller and coarse particles having diameters of 15 μm or larger need to be removed by classification, and therefore there is a problem that the toner yield is very low. Moreover, it is very difficult to uniformly disperse the colorant, the charge controlling agent, and the like in the thermoplastic resin in the pulverization method, and uneven dispersion thereof adversely affects the fluidity, developing ability, durability, obtainable image quality of the toner.

To overcome the aforementioned problems of the kneading pulverization method, a toner production method using a polymerization method has been proposed. The toner produced by the polymerization methods can be easily down sized in terms of the particle diameters thereof, and has a sharp particle size distribution compared to that of the toner obtained by the pulverization method, and moreover, with this method encapsulation by wax can be realized.

As the toner production method using such the polymerization method, there is disclosed a method of producing a toner in which as a toner binder, an elongation reaction product of urethane-modified polyester is used, and the toner has a working sphericity of 0.90 to 1.00 for the purpose of improving the fluidity, low temperature fixing ability, and hot offset resistance of the toner (for example, see Japanese Patent Application Laid-Open (JP-A) No. 11-133665).

Moreover, there is disclosed a method of producing a toner having excellent powder fluidity and transferring ability in the case where the toner is designed to be the toner of small particle diameters, as well as having excellent heat resistant storage stability, low temperature fixing ability, and hot offset resistance (for example, see JP-A Nos. 2002-287400 and 2002-351143).

Moreover, there is disclosed a method of producing a toner in which a toner binder having a stable molecular weight distribution is produced, and a maturing step for providing low temperature fixing ability and hot offset resistance to the toner is provided (for example, see Japanese Patent (JP-B) No. 2579150 and JP-A No. 2001-158819).

A method of introducing crystalline polyester by a polymerization method is also disclosed for the purpose of improving low temperature fixing ability of the toner. As the method of preparing a crystalline polyester dispersion liquid, JP-A No. 08-176310 discloses a preparation method of a dispersion liquid using a solvent for phase separation. However, by this method, only a coarse dispersion liquid containing dispersed elements having particle diameters of a few tens micrometers to a few hundreds micrometers is produced, and a dispersion liquid containing dispersed elements having the volume average particle diameter of 1.0 μm or smaller, which can be used in the production of the toner, cannot be obtained. For the purpose of reducing the size of the dispersed element of the crystalline polyester dispersion liquid, JP-A No. 2005-015589 discloses a method in which reduction in the size of particle diameters of dispersed element is attempted by mixing crystalline polyester monomers in a solvent, and heating and cooling, but the resulting dispersion liquid is not stable, and reduction in the size is not sufficient.

The method of producing a toner disclosed in JP-A Nos. 11-133665, 2002-287400, and 2002-351143 contains a high molecular weight processing step, in which an isocyanate group-containing polyester prepolymer is allowed to react with amine in a reaction system where an organic solvent and an aqueous medium are mixed to perform a polyaddition reaction.

However, the aforementioned method, and the toner obtained by the aforementioned method can provide improved hot offset resistance, but inhibit low temperature fixing, and reduce glossiness of an image after fixing, and thus they are not sufficient countermeasures to solve the problems.

Moreover, the method of producing a toner disclosed in Japanese Patent (JP-B) No. 2579150, and JP-A No. 2001-158819 is easily applied to a condensation polymerization reaction, which is a high temperature reaction, but the method cannot be applied to the reaction system mentioned above where the organic solvent and the aqueous medium are mixed unless various conditions are closely studied.

Moreover, in the method disclosed in JP-A Nos. 08-176310 and 2005-015589, the crystalline polyester is introduced in the polymerization method for improving fixing ability, but with this method a dispersion liquid containing stable dispersed elements having small diameters cannot be obtained. As a result, the particle size distribution of the toner is made worse, and the toner causes filming due to the exposed crystalline polyester on the surface of the toner. Accordingly, this method is also not sufficient to solve the problems mentioned above.

### SUMMARY OF THE INVENTION

The present invention aims to provide a toner that can give stable low temperature fixing ability, and heat resistant storage stability, without causing filming, as well as a developer containing the toner, a developer container housing developer therein, a process cartridge, an image forming apparatus, and an image forming method.

The present inventors have come to the insights based on their diligent researches that the conventional problems mentioned above can be solved by the following aspects, which lead to the present invention. The specific aspects of the present invention are as follows:

<1> A toner, containing:

a crystalline polyester resin; and

a non-crystalline polyester resin,

wherein the crystalline polyester resin has a melting point of 60° C. to 80° C., and

wherein the toner satisfies the relationship represented by the following formula:

(W1−W1′)/W1<0.50

where W1 is a temperature width at a 1/3 height of a height of an endothermic peak of the crystalline polyester resin on a differential scanning calorimetry curve of the toner at the time of an initial temperature elevation as measured by differential scanning calorimetry, and W1′ is a temperature width at a 1/3 height of a height of an endothermic peak of the crystalline polyester resin on a differential scanning calorimetry curve of the toner measured after the toner has been heated at 50° C. for 24 hours.

<2> The toner according to <1>, wherein the toner is obtainable by the method containing:

emulsifying or dispersing a dispersion liquid in an aqueous medium, the dispersion liquid containing an organic solvent, and toner materials including at least a binder resin and a releasing agent dissolved or dispersed in the organic solvent; and removing the organic solvent.

<3> The toner according to <2>, wherein the binder resin contained in the dispersion liquid contains a binder resin precursor.
<4> The toner according to any of <2> or <3>, wherein the dispersion liquid is an oil phase in which at least a colorant, the releasing agent, the crystalline polyester resin, a compound containing an active hydrogen group, and a binder resin precursor having a portion capable of reacting with the compound containing an active hydrogen group are dissolved or dispersed in the organic solvent, and the aqueous medium contains a dispersant therein,

wherein the emulsifying or dispersing contains dispersing the oil phase in the aqueous medium to obtain an emulsified dispersion liquid and allowing the binder resin precursor to react with the compound containing an active hydrogen group in the emulsified dispersion liquid, and

wherein the removing contains removing the organic solvent from the emulsified dispersion liquid.

<5> The toner according to <1>, wherein the toner is obtained by the method containing:

melting and kneading toner materials containing at least the crystalline polyester resin and the non-crystalline polyester resin;

pulverizing the kneaded product; and

classifying the pulverized product.

<6> The toner according to <5>, further containing:

carrying out annealing at the temperature lower than the temperature of the endothermic peak of the crystalline polyester resin by 5° C. to 15° C., before or after the classifying.

<7> The toner according to <1>, wherein the toner is obtained by the method containing:

dispersing the crystalline polyester resin and the non-crystalline polyester resin respectively in separate aqueous media to emulsify the crystalline polyester resin and the non-crystalline polyester resin as crystalline polyester resin particles, and non-crystalline polyester particles, respectively;

mixing the crystalline polyester resin particles, the non-crystalline polyester resin particles, a wax dispersion liquid, and a colorant dispersion liquid to prepare a dispersion liquid containing aggregated particles;

fixing the aggregated particles to form toner particles; and

washing the toner particles.

<8> The toner according to <7>, further containing:

carrying out annealing at the temperature lower than the temperature of the endothermic peak of the crystalline polyester resin by 5° C. to 15° C., before, during, or after the washing.

<9> A developer, containing:

the toner as defined in any one of <1> to <8>.

<10> A developer container, containing:

a container; and

the developer as defined in <9>, housed in the container.

<11> A process cartridge, containing:

a latent electrostatic image bearing member; and

a developing unit configured to develop the latent electrostatic image formed on the latent electrostatic bearing member with the toner as defined in any one of <1> to <8> to form a visible image,

wherein the process cartridge is detachably mounted in a main body of an image forming apparatus.

<12> An image forming apparatus, containing:

a latent electrostatic image bearing member;

a charging unit configured to uniformly charge a surface of the latent electrostatic image bearing member;

an exposing unit configured to expose the charged surface of the latent electrostatic image bearing member to light to form a latent electrostatic image;

a developing unit configured to develop the latent electrostatic image with the toner as defined in any one of <1> to <8> to form a visible image;

a transferring unit configured to transfer the visible image to a recording medium; and

a fixing unit configured to fix the visible image transferred to the recording medium thereon.

<13> An image forming method containing:

forming a latent electrostatic image on a latent electrostatic image bearing member;

developing the latent electrostatic image with the toner as defined in any one of <1> to <8> to form a visible image;

transferring the visible image to a recording medium; and

fixing the visible image transferred to the recording medium thereon.

The present invention provides a toner, which gives excellent low temperature fixing ability and desirable offset resistance, and can form images having desirable sharpness and of high quality for a long period of time without smearing a fixing device and images, as well as providing a developer containing the toner, a container housing the developer therein, a process cartridge, an image forming apparatus and an image forming method.

### BRIEF DESCRIPTION OF THE DRAWINGS

FIG. 1 is a diagram illustrating one example of the image forming apparatus of the present invention.

FIG. 2 is a diagram illustrating another example of the image forming apparatus of the present invention.

FIG. 3 is a diagram illustrating the tandem developing unit of FIG. 2.

FIG. 4 is a diagram illustrating one example of the process cartridge of the present invention.

### DETAILED DESCRIPTION OF THE INVENTION

### Toner

The toner of the present invention contains at least a crystalline polyester resin and a non-crystalline polyester resin, and may further contain other substances, if necessary.

The crystalline polyester resin contained in the toner of the present invention has a melting point of 60° C. to 80° C., and the toner satisfies the relationship of (W1−W1′)/W1<0.50, where W1 is a temperature width at a 1/3 height of a height of an endothermic peak of the crystalline polyester resin on a differential scanning calorimetry curve of the toner at the time of an initial temperature elevation as measured by differential scanning calorimetry, and W1′ is a temperature width at a 1/3 height of a height of an endothermic peak of the crystalline polyester resin on a differential scanning calorimetry curve of the toner measured after the toner has been heated at 50° C. for 24 hours.

When the melting point of the crystalline polyester resin is lower than 60° C., heat resistance storage stability of the resulting toner is deteriorated. When the melting point thereof is higher than 80° C., the resulting toner has poor low temperature fixing ability. Note that, in the present specification, “the melting point of the crystalline polyester resin” is defined as the temperature at which the maximum endothermic peak is present on the DSC curve measured by a differential scanning caloritometer.

Generally, the lower the melting point of the crystalline polyester resin is better for attaining low temperature fixing ability of the resulting toner, but the crystalline polyester resin having the low melting point has a problem that the crystalline polyester resin having the low melting point dissolves together with a non-crystalline polyester to thereby reduce the glass transition temperature of the resulting toner, which leads to poor image quality of resulting images and poor heat resistance storage stability of the resulting toner.

Meanwhile, it has been known that by heating the non-crystalline polyester resin melted together with the crystalline polyester resin at the temperature around the melting point of the crystalline polyester resin, crystallization of the crystalline polyester resin progresses to change more stable crystalline state. The toner satisfying the relationship of (W1−W1′)/W1<0.50 shows that the crystalline polyester resin and the non-crystalline polyester resin are not melted together, and therefore such the toner has both the low temperature fixing ability and heat resistance storage stability, and gives excellent quality of images.

The method for preventing the crystalline polyester resin and the non-crystalline polyester resin from being melted together during the production process of the toner is, for example, any of the following methods.

In the method for producing a toner in which the oil phase containing at least the crystalline polyester resin and the non-crystalline polyester resin as the binder resin component in the organic solvent is dispersed in the aqueous medium to obtain a dispersion liquid and the organic solvent is removed from the obtained dispersion liquid, the crystalline polyester resin is dissolved in the organic solvent as heated, and recrystallized as cooled. By heat-melting and cooling the crystalline polyester resin alone, it is possible to the crystalline polyester resin from being compatible to the non-crystalline polyester resin. In the case where the crystalline polyester resin is present together with the non-crystalline polyester resin during the aforementioned melt-heating and cooling, the crystalline polyester resin and the non-crystalline polyester resin are melted together at the time of the melt-heating, and therefore the crystalline polyester resin cannot effect its sharp melt properties in the resulting toner. From this reason, it is desirable that the aforementioned melt-heating and cooling be performed on only the crystalline polyester resin in the organic solvent. The dispersed particle diameter of the crystalline polyester resin precipitated during the cooling is varied depending on the concentration of the solution and the cooling rate. After cooling the dispersion liquid, the non-crystalline polyester resin is dissolved in the dispersion liquid, and the resultant is subjected to atomizing by means of a mechanical grinder to thereby prepare a crystalline polyester resin dispersion liquid.

In the case where only the crystalline polyester resin is dispersed in the organic solvent, the viscosity of the resulting dispersion liquid increases as the dispersed particle diameters decrease, and thus it is difficult to control the dispersed particle diameters to the ideal range, i.e. 0.1 μm to 1.0 μm without increasing the viscosity thereof. In order to reduce the viscosity, there is a method of reducing the concentration of the solution, but this method is not usable on practice. Therefore, it is preferred that the non-crystalline polyester resin be dissolved in the dispersion liquid after cooling, to thereby control the viscosity thereof, and then the dispersion liquid be subjected to mechanical grinding.

Moreover, use of the mechanical grinding device can increase the temperature of the dispersion liquid by applying higher shear to the dispersion liquid as the viscosity thereof increases, which melts the crystalline polyester resin and the non-crystalline polyester resin together. The melting of the crystalline polyester resin and the non-crystalline polyester resin together can be prevented by carrying out dispersing so as not to increase the temperature of the dispersion liquid to the temperature higher than the temperature at which the crystalline polyester resin is dissolved in the organic solvent.

The endothermic peak of the crystalline polyester resin for use in the toner of the present invention can be measured, for example, by the method described below using the DSC system (differential scanning calorimeter, Q-200, manufactured by TA INSTRUMENTS JAPAN INC.)

At first, about 5.0 mg of a toner sample is weight and added to an aluminum sample container. The sample container is placed on a holder unit and set in an electric furnace. Next, in a nitrogen atmosphere (flow rate: 50 mL/min), the sample is heated from −20° C. to 150° C. at a temperature increasing rate of 1° C./min, temperature modulation cycle of 60 seconds, and temperature modulation amplitude of 0.159° C. Thereafter, the sample is cooled from 150° C. to 0° C. at a temperature decreasing rate of 10° C./min. In this process, the DSC curve of the sample is measured with a differential scanning calorimeter (Q-200, TA INSTRUMENTS JAPAN INC.). From the obtained DSC curve, the endothermic peak from the initial temperature elevation is selected, and the temperature width at the position where the height thereof is 1/3 of the height from the base line to the top of the endothermic peak. The calculated temperature width is determined as W1.

Then, the toner sample is heated at 50° C. for 24 hours.

Thereafter, the DSC measurement is performed again on the toner sample in the same manner as that of the aforementioned initial temperature elevation, and the DSC curve thereof is measured. From the obtained DSC curve, the endothermic peak is selected, and the temperature width at the position where the height thereof is 1/3 of the height from the base line to the top of the endothermic peak. The calculated temperature width is determined as W1′.

As mentioned earlier, the toner satisfies the relationship of (W1−W1′)/W1<0.50 shows that the crystalline polyester resin and the non-crystalline polyester resin are compatible to each other.

Since the crystalline polyester resin contained in the toner of the present invention has crystallinity, the resulting toner has thermofusion properties that the viscosity of the toner dramatically decreases at around the fixing onset temperature (fusion onset temperature) because of the crystallinity. Specifically, the toner has the desirable heat resistant storage stability just below the fusion onset temperature, and shows dramatic viscosity reduction (sharp melt) at the fusion onset temperature to be fixed, so that the toner having both excellent heat resistant storage stability and low temperature fixing ability can be designed. Moreover, such the toner has also excellent the releasing width (i.e. difference between the minimum fixing temperature and hot offset occurring temperature).

The toner for developing latent electrostatic images of the present invention can be produced, for example, by emulsifying or dispersing in an aqueous medium a liquid in which toner materials containing at least a binder resin and a releasing agent is dissolved or dispersed in an organic solvent, and removing the organic solvent. The liquid in which the toner materials are dissolved or dispersed in the organic solvent preferably further contains a binder resin precursor as the binder resin component.

The organic solvent used for dispersing the crystalline polyester resin is selected from those capable of completely dissolve the crystalline polyester resin therein to form an uniform solution, and can cause phase separation from the crystalline polyester resin as cooled to form an ununiform opaque solution.

Specifically, the organic solvent is selected from organic solvents exhibit nonsolvent properties at the temperature lower than (Tm-40)° C. based on the melting temperature (Tm) of the crystalline polyester resin, and exhibit properties of good solvent at the temperature equal to or higher than (Tm-40)° C., and examples thereof include toluene, ethyl acetate, butyl acetate, methyl ethyl ketone, and methyl isobutyl ketone. These may be used independently, or in combination.

The mechanical grinder used for atomizing the crystalline polyester resin precipitated by cooling is, for example, any of commercially available grinders. Examples thereof include a bead mill, a ball mill, and a wet-type atomization device (e.g. Ultimizer of Sugino Machine Limited).

As the method for producing the toner of the present invention, a dissolution suspension method, a pulverization method, and an emulsification aggregation method are each specifically explained hereinafter.

### Dissolution Suspension Method

The production method of the toner of the present invention is preferably the method that contains: dissolving a compound capable of elongation or crosslinking reaction with a binder resin precursor in an oil phase, which is obtained by dissolving in an organic solvent at least a colorant, a releasing agent, a crystalline polyester dispersion liquid, the binder resin precursor, and other binder resin components; dispersing the oil phase in an aqueous medium containing a fine particle dispersant to thereby obtain an emulsified dispersion liquid; allowing the binder resin precursor to proceed a crosslinking and/or elongation reaction in the emulsified dispersion liquid; and removing the organic solvent.

The crystalline polyester for use in the present invention is appropriately selected depending on the intended purpose without any restriction, but it is preferably a polyester resin synthesized from an alcohol component containing a C2-C20 diol compound or derivatives thereof, and an acid component containing an polycarboxylic acid compound (e.g. aliphatic dicarboxylic acid, aromatic dicarboxylic acid, and alicyclic dicarboxylic acid) or derivatives thereof.

The crystalline polyester resin is synthesized, for example, using a C2-C12 saturated aliphatic diol compound as an alcohol component, in combination with at least C2-C12 dicarboxylic acid having a double (C═C) bond or C2-C12 saturated dicarboxylic acid as an acid component. Examples of the C2-C12 saturated aliphatic diol compound include 1,4-butanediol, 1,6-hexanediol, 1,8-octanediol, 1,10-decanediol, 1,12-dodecanediol, and derivatives thereof. Examples of the dicarboxylic acid include fumaric acid, 1,4-butanedioic acid, 1,6-hexanedioic acid, 1,8-octanedioic acid, 1,10-decanedioic acid, 1,12-dodecanedioic acid, and derivatives thereof.

Among them, the crystalline polyester resin is preferably consisted of the saturated C4-12 diol component selected from 1,4-butanediol, 1,6-hexanediol, 1,8-octanediol, 1,10-decanediol, 1,12-dodecanediol, and the saturated C4-12 dicarboxylic acid component selected from 1,4-butanedioic acid, 1,6-hexanedioic acid, 1,8-octanedioic acid, 1,10-decanedioic acid, 1,12-dodecanedioic acid is particularly preferable because the resulting crystalline polyester resin has high crystallinity and shows drastic viscosity change at around the melting point thereof.

The binder resin for use in the present invention contains the polyester resin because the desirable low temperature fixing ability of the toner is obtained, but the binder resin preferably further contain a non-modified polyester resin (a polyester resin that is not modified). Note that, the molecular weight, monomer unit, and the like of the polyester resin may be appropriately selected depending on the intended purpose. Moreover, the binder resin may further contain a resin other than the polyester resin. Examples of the resin other than the polyester resin include: homopolymers or copolymers of styrene-based monomers, acryl-based monomers, and methacryl-based monomers; and resins such as polyol resins, phenol resins, silicone resins, polyurethane resins, polyamide resins, furan resins, epoxy resins, xylene resins, terpene resins, coumarone-indene resins, polycarbonate, and petroleum resins. These may be used independently, or in combination.

The polyester resin is obtained through a dehydration condensation between polyhydric alcohol and polycarboxylic acid. Examples of the polyhydric alcohol for use include dihydric alcohols such as ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, and divalent alcohols obtained by adding cyclic ether such as ethylene oxide and propylene oxide to hydrogenated bisphenol A or bisphenol A.

Note that, for crosslinking the polyester resin, it is preferred that the trihydric or higher polyhydric alcohol be used in combination, and examples of such the alcohol include sorbitol, 1,2,3,6-hexanetetrol, 1,4-sorbitan, pentaerythritol, dipentaerythritol, tripentaerythritol, 1,2,4-butanetriol, 1,2,5-pentatriol, glycerol, 2-methylpropanetriol, 2-methyl-1,2,4-butanetriol, trimethylol ethane, trimethylol propane, and 1,3,5-trihydroxybenzene.

Examples of the polycarboxylic acid include: benzene dicarboxylic acid such as phthalic acid, isophthalic acid, and terephthalic acid, and anhydrides thereof; alkyl dicarboxylic acid such as succinic acid, adipic acid, sebacic acid, and azelaic acid, and anhydrides thereof; unsaturated dibasic acid such as maleic acid, citraconic acid, itaconic acid, alkenyl succinic acid, fumaric acid, and mesaconic acid; unsaturated dibasic acid anhydrides such as maleic anhydride, citraconic anhydride, itaconic anhydride, and alkenyl succinic anhydride; and trivalent, or higher polycarboxylic acid such as trimellitic acid, pyromellitic acid, 1,2,4-benzene tricarboxylic acid, 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxy-2-methyl-2-methylenecarboxypropane, tetrakis(methylenecarboxy)methane, 1,2,7,8-octane tetracarboxylic acid, and ENPOL trimer acid, anhydride thereof, and partial lower alkyl esters thereof.

In view of the fixing ability and offset resistance of the resulting toner, the polyester has a THF insoluble component whose molecular weight preferably has at least one peak in the region of 3,000 to 50,000, more preferably in the region of 5,000 to 20,000 in its molecular weight distribution. Moreover, an amount of the THF insoluble component of the unmodified polyester having the molecular weight of 100,000 or lower is generally 60% by mass to 100% by mass. Note that, the molecular weight distribution of the unmodified polyester can be measured by means of gel permeation chromatography (GPC) using THF as an eluent.

The binder resin for use in the present invention preferably contains a polyester resin having a functional group capable of reacting with the active hydrogen group (also referred to as “polyester prepolymer” hereinafter). As the polyester prepolymer, those having isocyanate groups can be used. Such the polyester prepolymer can be obtained, for example, through a reaction between the polyester resin having the active hydrogen group and polyisocyanate.

Examples of the active hydrogen group contained in the polyester resin include hydroxyl groups (e.g., an alcoholic hydroxyl group and phenolic hydroxyl group), amino groups, carboxyl groups, and mercapto groups.

It is preferred that at least part of the polyester resin and the polyester prepolymer be compatible to each other in view of low temperature fixing ability and anti offset resistance. Therefore, it is preferred that the formulation of the polyester resin and the formulation of the polyester prepolymer be similar.

Examples of the polyisocyanate include: aliphatic polyisocyanate (e.g., tetramethylene diisocyanate, hexamethylene diisocyanate, and 2,6-diisocyanate methyl caproate); alicyclic polyisocyanate (e.g. isophorone diisocyanate, and cyclohexylmehane diisocyanate); aromatic diisocyanate (e.g. tolylene diisocyanate, and diphenylmethane diisocyanate); aromatic aliphatic diisocyanate (e.g. α,α,α′,α′-tetramethyl xylylene diisocyanate); and isocyanirates. These may be used independently, or in combination. Moreover, as the polyisocyanate, those blocked with phenol derivatives, oxime, caprolactam, or the like may be used.

When the polyester containing a hydroxy group and the polyisocyanate are reacted, an equivalent mass ratio of the isocyanate groups in the polyisocyanate to the hydroxy groups contained in the polyester containing a hydroxy group is generally 1 to 5, preferably 1.2 to 4, and even more preferably 1.5 to 2.5. When the ratio thereof is more than 5, the low temperature fixing ability of the toner may be impaired. When the ratio thereof is less than 1, the urea content in the modified polyester resin obtained through a crosslinking and/or elongation reaction described later decreases, lowering the hot offset resistance of the resulting toner.

An amount of the constitutional unit derived from the polyisocyanate in the polyester prepolymer is generally 0.5% by mass to 40% by mass, preferably 1% by mass to 30% by mass, and more preferably 2% by mass to 20% by mass. When the amount thereof is less than 0.5% by mass, the resulting toner has poor hot offset resistance, and may not be able to attain both the heat resistance storage stability and the low temperature fixing ability. When the amount thereof is more than 40% by mass, the low temperature fixing ability of the resulting toner may be poor.

The number (on average) of isocyanate groups per molecular of the polyester prepolymer is generally 1 or more, preferably 1.5 to 3, and even more preferably 1.8 to 2.5. When the number of the isocyanate group is less than 1, a molecular weight of the modified polyester resin after the crosslinking and/or elongation reaction reduces, lowering hot offset resistance of a resulting toner.

A mass ratio of the polyester resin to the polyester prepolymer is generally 5/95 to 50/50, preferably 10/90 to 30/70, and more preferably 12/88 to 25/75. When the mass ratio thereof is less than 5/95, the hot offset resistance of the resulting toner is poor, and the resulting toner may not be able to attain both the heat resistance storage stability and low temperature fixing ability. When the mass ratio thereof is more than 50/50, the low temperature fixing ability of the resulting toner may be poor.

It is preferred in the present invention that the polyester prepolymer and the compound having an active hydrogen group (may also be referred to as “a crosslinking agent and/or elongation agent” hereinafter) be allowed to react (may also be referred to as “crosslinking and/or elongation reaction” hereinafter) in an aqueous medium.

As the crosslinking agent and/or elongation agent, amines can be used. Examples of the amines include divalent amine, tri or higher valent amine, amino alcohol, amino mercaptan, and amino acid.

Examples of the divalent amines include: aromatic diamine (e.g. phenylene diamine, diethyl toluene diamine, and 4,4′-diaminodiphenyl methane); alicyclic diamine (e.g. 4,4′-diamino-3,3′-dimethyldichlorohexyl methane, diamine cyclohexane, and isophorone diamine); and aliphatic diamine (e.g. ethylene diamine, tetramethylene diamine, and hexamethylene diamine).

Examples of the tri or higher valent amine include diethylene triamine, and triethylene tetramine. Examples of the amino alcohol include ethanol amine, hydroxyethyl aniline. Examples of the amino mercaptan include aminoethylmercaptan, and aminopropylmercaptan. Examples of the amino acid include amino propionic acid, and amino caproic acid. Moreover, as the amines, compounds in which amino groups are blocked may be used, and specific examples of such compounds include a ketimine compound, and an oxazolidine compound, both of which the amino group in the compound is blocked with ketones (e.g. acetone, methyl ethyl ketone, and methyl isobutyl ketone). Among them, the divalent amine, or a mixture of the divalent amine and a small amount of the tri or higher valent amine is preferable.

Moreover, a molecular weight of the modified polyester resin may be controlled, if necessary, using a terminator during the crosslinking and/or elongation reaction. Examples of the terminator include: monoamines (e.g. diethylamine, dibutylamine, butylamine, and laurylamine), and compounds in which an amino group of monoamine is blocked, for example, with ketones (e.g. acetone, methyl ethyl ketone, and methyl isobutyl ketone), such as ketimine compounds and oxazoline compounds.

For the crosslinking and/or elongation reaction, an equivalent mass ratio of the amino group contained in the amines to the isocyanate groups contained in the polyester prepolymer is preferably 1/3 to 3/1, more preferably 1/2 to 2/1, and even more preferably 2/3 to 3/2. When the equivalent mass ratio thereof is more than 3/1 or less than 1/3, the molecular weight of the resulting modified polyester resin is small, which may lead to poor hot offset resistance of the resulting toner.

The glass transition temperature (Tg) of the binder resin is preferably 35° C. to 80° C., more preferably 40° C. to 75° C. in view of storage stability of the resulting toner. When Tg thereof is lower than 35° C., the resulting toner may be deteriorated when it is in the high temperature atmosphere, and moreover the resulting toner tends to cause offset at the time of fixing. When Tg thereof is higher than 80° C., the fixing ability of the resulting toner may be poor.

### Pulverization Method

The toner of the present invention can also be produced through the production method including a melt kneading step, a cooling step, a pulverizing step, a classifying step, and a surface treatment step. Specifically, the toner can be produced by the production method including (1) a step of kneading a toner composition containing at least a binder resin, (2) a step of cooling the kneaded toner composition and pulverizing the cooled kneaded product (coarse grinding, and fine grinding), (3) a step of adding at least part of external additives to the pulverized powder, (4) a step of classifying, (5) a step of returning the fine powder component outside the predetermined particle size range selected by the classification to the kneading step for recycling, and (6) a step of adding the external additives (the rest of the external additives) to the powder within the predetermined particle size range selected by the classification.

In the step of (1), it is preferred that raw materials such as a binder resin, a colorant, and a releasing agent be pre-mixed by means of HENSCHEL MIXER or the like in advance, and then the raw materials be supplied to the melt-kneading step. The melt-kneading of the raw materials can be performed in accordance with a conventional method by means of a conventional kneader such as a sealed kneader, a uniaxial or biaxial kneader, and an open roll kneader.

In the course of the step (2) of cooling the kneaded toner composition and pulverizing the cooled kneaded product, the kneaded toner composition is cooled first, and then cooled kneaded product is pulverized so that the pulverized product obtained by the coarse grinding (coarsely pulverized product) has the average particle diameter of preferably 0.03 mm to 4 mm, more preferably 0.1 mm to 2 mm. In the present specification, the average particle diameter of the coarsely pulverized product means the average value of the maximum lengths of the project area of particles observed under a microscope.

Examples of the pulverizer used in the fine grinding include an atomizer, and ROTOPLEX.

Subsequently, the fine grinding is performed by means of a jet mill such as an impact plate mill, or a rotary type mechanical mill. In the case where the jet mill is used for the fine grinding, the wind pressure during the pulverization, i.e., the pressure of the pulverizing air introduced to the pulverization nozzle, is preferably 0.2 MPa to 1 MPa, more preferably 0.3 MPa to 0.8 MPa.

The weight average particle diameter of the crushed powder is preferably 2 μm to 10 μm, more preferably 2 μm to 7 μm, in view of image quality.

The step (3) of adding at least part of the additives before classification can be carried out, for example, by adding the part of the external additives to the pulverized powder by means of a mixer capable of high-speed stirring, such as HENSCHEL MIXER, and a super mixer.

By classifying and removing the fine pulverized product in the step (4) of classifying, a toner can be obtained. Examples of the classifying device for use in the classification include a wind classifier, an inertial classifier, a rotary classifier, and a sieve classifier.

Moreover, it is preferred that annealing be performed before or after the classification. Specifically, the toner obtained after the pulverizing step, or the toner classified by the classification step is heated 50° C. for 24 hours, to thereby recrystallize the crystalline polyester contained therein. The annealing is preferably performed at the temperature lower than the endothermic peak temperature of the crystalline polyester contained in the toner by 5° C. to 15° C.

In the (5) step of returning the fine powder component outside the predetermined particle size range selected by the classification to the kneading step for recycling, the fine powder component obtained by the classification step is collected and returned to the kneading step.

In the (6) step of adding the external additives (the rest of the external additives) to the component within the predetermined particle size range selected by the classification, at least part of the external additives (the rest of the external additives) can be added to the pulverized powder, for example, by means of a mixer capable of high-speed stirring such as HENSCHEL MIXER, and a super mixer, in the same manner as in the step of (3).

### <Emulsification Aggregation Method>

The toner of the present invention can also be produced by the method including: dispersing a crystalline polyester resin and a non-crystalline polyester resin respectively in separate aqueous media to form crystalline polyester resin particles and non-crystalline polyester resin particles to thereby emulsify (emulsification step); mixing the resin particles, a wax dispersion liquid, and a colorant dispersion liquid to thereby prepare a dispersion liquid containing aggregated particles (aggregation step); heating the dispersion liquid containing aggregated particles to the temperature equal to or higher than the glass transition temperature of the resin particles to thereby fuse the aggregated particles into toner particles (fusing step); and washing the toner particles. One example of such the method will be explained hereinafter.

### Emulsification Step

The formation of the crystalline polyester particles can be carried out, for example, by applying a shear force to the solution, in which the aqueous medium and the crystalline polyester are mixed, by means of a disperser. At this time, heat may be applied for reducing the viscosity of the resin component to form particles. Moreover, a dispersant may be used for stabilizing the dispersed resin particles. Furthermore, in the case where the resin is soluble in a solvent forming an oil phase, and having the relatively low solubility to water, the resin is made dissolved in such the solvent to form an oil phase, and the oil phase is dispersed into particles in water together with a dispersant or polyelectrolyte, and the solvent is evaporated and removed by heating or reducing pressure to thereby prepare a dispersion liquid of the crystalline polyester particles.

A dispersion liquid of the non-crystalline polyester particles is also prepared in the same manner as described above.

Examples of the aqueous medium include: water such as distilled water and ion-exchanged water; and alcohols, but the aqueous medium is preferably water.

The disperser for use in the emulsifying step is, for example, a water-soluble polymer such as polyvinyl alcohol, methyl cellulose, ethyl cellulose, hydroxyethyl cellulose, carboxymethyl cellulose, sodium polyacrylate, and sodium polymethacrylate; an anionic surfactant such as sodium dodecylbenzenesulfonate, sodium octadecylsulfate, sodium oleate, sodium laurate, and potassium stearate; a cationic surfactant such as laurylamine acetate, stearylamine acetate, and lauryltrimethyl ammonium chloride; an amphoteric surfactant such as lauryldimethyl amine oxide; a nonionic surfactant such as polyoxyethylene alkyl ether, polyoxyethylene alkylphenyl ether, and polyoxyethylene alkyl amine; an inorganic salt such as tricalcium phosphate, aluminum hydroxide, calcium sulfate, calcium carbonate, and barium carbonate; or the like.

The dispersing method of the emulsion is, for example, dispersing the emulsion by means of a disperser, and examples of the disperser include a homogenizer, a homomixer, a pressure kneader, an extruder, and a media disperser. The size of the resin particles is preferably the average particle diameter (volume average particle diameter) of 0.01 μm to 1.0 μm.

The dispersing method of the colorant is not particularly restricted, and is, for example, a commonly known dispersion method by means of a rotary shear homogenizer, or a ball mill, sand mill or Dyno-mill having a media.

If necessary, the aqueous dispersion liquid of the colorant may be prepared by using a surfactant, or an organic solvent-based dispersion liquid of the colorant may be prepared by using a dispersant. Such the dispersion liquid of the colorant may be referred to as a “colorant dispersion liquid” hereinafter. The surfactant or dispersant used for dispersing can be the dispersant that can be used for dispersing the crystalline polyester resin or the like.

An amount of the colorant to be added is preferably 1% by mass to 20% by mass, more preferably 1% by mass to 10% by mass, even more preferably 2% by mass to 10% by mass, and particularly preferably 2% by mass to 7% by mass, relative to the total amount of the polymer.

In the case where the colorant is added and mixed at the emulsification step, mixing of the polymer and the colorant can be carried out by mixing the colorant or an organic solvent-based dispersion liquid of the colorant to the organic solvent solution of the polymer.

### Aggregation Step

During the aggregation step, the obtained crystalline polyester resin particle dispersion liquid, non-crystalline polyester resin particle dispersion liquid, the colorant dispersion liquid, and the like are mixed to form a liquid mixture, and the liquid mixture is heated at the temperature equal to or lower than the glass transition temperature of the non-crystalline polyester resin to cause aggregation, to thereby form aggregated particles.

The formation of the aggregated particles is carried out by adjusting the pH of the liquid mixture to become acid with stirring. The pH is preferably in the range of 2 to 7, more preferably 2.2 to 6, and even more preferably 2.4 to 5. For this process, use of an aggregating agent is also effective.

The aggregating agent for use is preferably a surfactant having a reverse charge to that of the surfactant used as the dispersant, an inorganic metal salt, or a bivalent or higher velent metal complex. Use of the metal complex is particularly preferable as an amount of the surfactant for use is reduced, and the charging properties improve.

Examples of the inorganic metal salt include: metal salts such as calcium chloride, calcium nitrate, barium chloride, magnesium chloride, zinc chloride, aluminum chloride, and aluminum sulfate; and organic metal salt polymers such as polyaluminum chloride, polyaluminum hydroxide, and calcium polysulfide. Among them, aluminum salts and polymers thereof are particularly preferable. To attain the sharper particle size distribution, the valence of the inorganic metal salt is more preferably bivalence over monovalence, trivalence over bivalence, tetravalence over trivalence.

In the case where the toner particles are produced, it is preferred that only the resin particle dispersion liquid be added to the aggregation system to aggregate resin particles to each other, and then the dispersion liquid of the colorant or releasing agent be added. In this manner, any interference in aggregation of resin particles due to the presence of releasing agent particles and the like can be avoided, and toner particles of desirable structures can be effectively formed.

The toner having a structure that a surface of the aggregated particles serving as a core is covered with the non-crystalline polyester resin may be produced by further adding the non-crystalline polyester resin particles to the aggregated particles which have been formed to have desirable particle diameters. In this case, the non-crystalline polyester resin particles are preferably non-crystalline polyester resin particles having high molecular weight because the crystalline polyester resin is secured within the toner without easily being exposed to the surface of the toner particle. In the case where the non-crystalline polyester resin particles are further added, the aggregating agent may be added, or pH adjustment may be performed before adding the non-crystalline polyester resin particles.

### Fusing Step

In the fusing step, progression of the aggregation is stopped by increasing the pH of the suspension liquid of the aggregated particles to the range of 3 to 9 with stirring in the same stirring conditions as in the aggregation step, and the aggregated particles are fused together by heating at the temperature equal to or higher than the Tg of the high molecular weight non-crystalline polyester resin or Tm of the crystalline polyester resin.

The duration for the heating may be the duration long enough to fuse the aggregated particles, and may be 0.5 hours to 10 hours. After the fusing, the particles are cooled to thereby obtain fused particles. The fused particles obtained through the fusing become toner particles through a solid-liquid separation process such as filtration, and optionally a washing process and drying process.

As mentioned above, the particles are fused by heating to the temperature equal to or higher than the glass transition temperature. In the case the crystalline polyester and the non-crystalline polyester are used, part thereof is melted together at the time of the fusing, and therefore annealing may be performed during the toner production process. The annealing can be performed before or during the washing process, moreover, during the drying process or after the drying process.

The annealing is preferably performed at the temperature lower than the endothermic peak temperature of the crystalline polyester by 5° C. to 15° C. By this process, the crystalline polyester resin can be recrystallized.

### Developer

The developer of the present invention contains the toner of the present invention, and may further contain other components such as a carrier, and the developer of the present invention can be used as a one-component developer comprised of the toner, or a two-component developer comprised of the toner and the carrier. Use of the developer of the present invention as the two-component developer is preferable in view of its long service life or the like when used in a high-speed printer and the like corresponding to the recent increased speed in information processing. The developer can be used in various electrophotographic methods known in the art, such as a magnetic one-component developing method, a non-magnetic one-component developing method, and a two-component developing method.

When the developer of the present invention is used as a one-component developer, a change in the particle diameters of the toner is small even after supplying the toner to compensate the consumed amount, filming of the toner to the developing roller and fusion of the toner to members such as a blade for forming the mass of the toner into a thin layer can be prevented, and desirable and stable developing properties can be attained.

When the developer of the present invention is used as a two-component developer, a change in the particle diameters of the toner is small even after supplying the toner to compensate the consumed amount over a long period of time, and desirable and stable developing properties can be attained even after stirring the developer for a long period of time in a developing device.

An amount of the carrier in the two-component developer is preferably 90% by mass to 98% by mass, more preferably 93% by mass to 97% by mass.

The carrier is not particularly restricted, but it is preferred that the carrier contain a core and a resin layer covering the core.

The material of the core is, for example, a manganese-strontium based material of 50 emu/g to 90 emu/g, a manganese-magnesium based material of 50 emu/g to 90 emu/g, or the like, and two or more of these materials may be used in combination. High magnetic materials such as the iron of 100 emu/g or higher, and the magnetite of 75 emu/g to 120 emu/g are preferably used as the core for securing the desirable image density. Moreover, a weak magnetic material such as a cupper-zinc (Cu—Zn) based material of 30 emu/g to 80 emu/g is preferable because the resulting carrier enables to reduce the impact of the toner brush onto a photoconductor, and therefore it is advantageous for forming high quality images.

The volume average particle diameter (D₅₀) of the core is appropriately selected depending on the intended purpose without any restriction, but it is generally 10 μm to 150 preferably 20 μm to 80 μm. When D₅₀ thereof is smaller than 10 μm, the proportion of the fine particles in the particle size distribution of the carrier increases, and therefore the magnetization per carrier particle is small, which may cause scattering of the carrier. When D₅₀ thereof is larger than 150 μm, the specific area of the resulting particle of the carrier is small, which may cause scattering of the carrier. Use of the core in such the size may lower the reproducibility of an image especially in a solid imaging part, when a full color image having a large area of the solid image part is printed.

Examples of the material of the resin layer include an amino-based resin, a polyvinyl-based resin, a polystyrene-based resin, a halogenated olefin resin, a polyester-based resin, a polycarbonate-based resin, a polyethylene resin, a polyvinyl fluoride resin, a polyvinylidene fluoride resin, a polytrifluoroethylene resin, a polyhexafluoropropylene resin, a copolymer of vinylidene fluoride and an acrylic monomer, a copolymer of vinylidene fluoride and vinyl fluoride, a fluoroterpolymer (e.g. a terpolymer of tetrafluoroethylene, vinylidene fluoride, and non-fluoride monomer), and a silicone resin. Two or more of them may be used in combination.

Examples of the amino-based resin include a urea-formaldehyde resin, a melamine resin, a benzoguanamine resin, a urea resin, a polyamide resin, and an epoxy resin. Examples of the polyvinyl-based resin include an acryl resin, polymethyl methacrylate, polyacrylonitrile, polyvinyl acetate, polyvinyl alcohol and polyvinyl butyral. Examples of the polystyrene-based resin include polystyrene, and a styrene-acryl copolymer. Examples of the halogenated olefin resin include polyvinyl chloride. Examples of the polyester-based resin include polyethylene terephthalate, and polybutylene terephthalate.

Moreover, the resin layer may contain conductive powder, if necessary. Examples of the material of the conductive powder include metal, carbon black, titanium oxide, tin oxide and zinc oxide. The average particle diameter of the conductive powder is preferably 1 μm or smaller. When the average particle diameter thereof is larger than 1 μm, it may be difficult to control the electric resistance.

The resin layer can be formed, for example, by preparing a coating liquid by dissolving a silicone resin or the like in a solvent, applying the coating liquid onto the surface of the core by the conventional coating method, drying and baking the coating liquid. Examples of the coating method include dip coating, spray coating, and brush coating. Examples of the solvent include toluene, xylene, methyl ethyl ketone, methyl isobutyl ketone, and butyl cellosolve acetate. Moreover, the baking method may be of external heating or internal heating, and examples of the baking method include methods using a fixed-type electric furnace, a flow-type electric furnace, a rotary electric furnace, a burner furnace, or micro waves.

An amount of the resin layer in the carrier is preferably 0.01% by mass to 5.0% by mass. When the amount of the resin layer in the carrier is less than 0.01% by mass, it may be difficult to form a uniform resin layer on the surface of the core. When the amount thereof is more than 5.0% by mass, the particles of the resulting carrier may cause aggregations, and therefore uniform particles of the carrier may not be obtained.

The developer of the present invention can be suitably used for image formation in accordance with various electrophotographic methods known in the art, such as a magnetic one-component developing method, a non-magnetic one-component developing method, and a two-component developing method.

### Developer Container

The developer container of the present invention includes a container and the developer of the present invention housed in the container. The container is appropriately selected from those known in the art without any restriction, and examples thereof include a container including a container main body and a cap.

The size, shape, structure, material, and the like of the container main body is not particularly restricted, but the shape thereof is preferably a cylinder, or the like, and more preferably a cylinder in which a convex-concave pattern is provided in spiral on the internal perimeter surface of the cylinder so that the contents, i.e. the developer, can be transported to the side of the discharging outlet by rotating, and part of or the entire spiral convex-concave pattern functions as bellows. Moreover, the material of the container main body is not particularly restricted, but it is preferably a material giving the dimensional accuracy. Examples of such the material include resinous materials such as a polyester resin, a polyethylene resin, a polypropylene resin, a polystyrene resin, a polyvinyl chloride resin, polyacrylic acid, a polycarbonate resin, an ABS resin, and a polyacetal resin.

The developer container is easy to store, transport, and the like, and is excellent in handling. Therefore, the developer container can be detachably mounted in the below-mentioned process cartridge, image forming apparatus, and the like, and used for supplying the developer.

### Image Forming Apparatus and Image Forming Method

The image forming method of the present invention contains at least a latent electrostatic image forming step, a developing step, a transferring step, and a fixing step, preferably further contains a cleaning step, and optionally may further contain, for example, a diselectrification step, a recycling step, and a controlling step.

The image forming apparatus of the present invention preferably contains at least a latent electrostatic image bearing member, a latent electrostatic image forming unit, a developing unit, a transferring unit, and a fixing unit, more preferably further contains a cleaning unit, and optionally may further contain, for example, a diselectrification unit, a recycling unit, and a controlling unit.

The image forming method of the present invention can be carried out by means of the image forming apparatus of the present invention, the latent electrostatic image forming step can be carried out with the latent electrostatic image forming unit, the developing step can be carried out with the developing unit, the transferring step can be carried out with the transferring unit, the fixing step can be carried out with the fixing unit, and other steps mentioned above can be carried out with other units mentioned above.

The latent electrostatic image forming step is forming a latent electrostatic image on the latent electrostatic image bearing member such as a photoconductive insulator, a photoconductor and the like. The material, shape, structure, size and the like of the latent electrostatic image bearing member are appropriately selected from those known in the art without any restriction, but the shape thereof is preferably a drum shape. Moreover, examples of the photoconductor include: an inorganic photoconductor such as amorphous silicon, and selenium; and an organic photoconductor such as polysilane, and phthalopolymethine. Among them, the amorphous silicon photoconductor is preferable as it has a long service life.

A latent electrostatic image can be formed, for example, by uniformly charging the surface of the latent electrostatic image bearing member, and exposing the charged surface of the latent electrostatic image bearing member to light imagewise, and the latent electrostatic image can be formed by using the latent electrostatic image forming unit. The latent electrostatic image forming unit contains, for example, at least a charging unit configured to apply a voltage to the surface of the latent electrostatic image bearing member to uniformly charge the surface of the latent electrostatic image bearing member, and an exposing unit configured to expose the surface of the latent electrostatic image bearing member to light imagewise.

The charging unit is not particularly restricted, and examples thereof include conventional contact chargers known in the art equipped with conductive or semiconductive roller, brush, film, rubber blade, or the like, and conventional non-contact charger using corona discharge such as corotron and scorotron.

The exposing unit is not particularly restricted, as long as it is capable of exposing the charged surface of the latent electrostatic image bearing member by the charging unit to light imagewise, and examples thereof include various exposing devices such as a reproduction optical exposing device, a rod-lens array exposing device, a laser optical exposure device, and a liquid crystal shutter optical device Note that, a photo-image black irradiation electrophotographic system in which exposure is performed imagewise from the back surface of the latent electrostatic image bearing member may be applied for the exposure.

The developing step is developing the latent electrostatic image with the developer of the present invention to form a toner image, and a visible image (i.e. the toner image) can be formed with the developing unit. The developing unit is not particularly restricted, as long as it is capable of performing development using the developer of the present invention. For example, the one at least having a developing device housing the developer of the present invention, and capable of providing a toner to the latent electrostatic image in a contact or non-contact manner can be used as the developing unit, and the developing unit is preferably a developing device equipped with the developer container of the present invention. The developing unit may be employ a dry developing system, or wet developing system, and may be a developing unit for a singly color, or a developing unit for a multi-color. Examples of the developing device include a device having a stirrer configured to charge the developer of the present invention by frictions from stirring, and a rotatable magnetic roller.

In the developing unit, for example, the toner and the carrier are mixed and stirred, and the toner is charged by the friction from the stirring. The charged toner is held on the surface of the rotatable magnetic roller in the form of a brush to form a magnetic brush. The magnetic roller is provided adjacent to the latent electrostatic image bearing member, part of the toner forming the magnetic brush on the surface of the magnetic roller is moved to the surface of the latent electrostatic image bearing member by electrical attraction force. As a result, the latent electrostatic image is developer with the toner to form a toner image on the surface of the latent electrostatic image bearing member. Note that, the developer housed in the developing unit is the developer of the present invention, but it may be a one-component developer or two-component developer.

The transferring step is charging the latent electrostatic image bearing member, on which the toner image has been formed, for example, by means of a transfer charging unit, to transfer the toner image to a recording medium, and the transferring step can be carried out by the transferring unit. The transferring step preferably include a primary transferring step and a secondary transferring step, where the primary transferring step is transferring the toner image to an intermediate transferring member, and the secondary transferring step is transferring the toner image transferred to the intermediate transferring member to a recording medium. Moreover, the more preferable embodiment of the transferring step contains a primary transferring step and a secondary transferring step where the primary transferring step is transferring toner images, which have been formed with the toners of two or more colors, preferably full color, are respectively transferred to an intermediate transferring member to form a composite toner image, and the secondary transferring step is transferring the composite toner image formed on the intermediate transferring member to a recording medium.

The transferring unit preferably contains a primary transferring unit configured to transfer a toner image to an intermediate transferring member to form a composite toner image, and a secondary transferring unit configured to transfer the composite toner image formed on the intermediate transferring medium to a recording medium. The intermediate transferring member is not particularly restricted, and examples thereof include an endless transfer belt. Moreover, the transferring unit (the primary transferring unit, the secondary transferring unit) preferably contains at least a transferrer configured to charge and release the toner image formed on the latent electrostatic image bearing member to the side of the recording medium. Note that, the transferring unit may contain one charger, or a plurality of chargers.

Examples of the transferrer include a corona transferrer utilizing corona discharge, a transfer belt, a transfer roller, a pressure transfer roller, and an adhesion transferrer.

The recording medium is appropriately selected from recording media (recording paper) known in the art without any restriction.

The fixing step is fixing the toner image transferred to the recording medium, and the fixing can be performed by means of the fixing unit. In the case where the toners of two or more colors are used, fixing may be performed every time when the toner of each color is transferred to the recording medium. Alternatively, fixing may be performed after the toners of all the colors are transferred to the recording medium in a laminated state. The fixing unit is not particularly restricted, and conventional heating pressurizing members known in the art can be used as the fixing unit. Examples of the heating and pressurizing unit include a combination of a heating roller and a pressure roller, and a combination of a heating roller, a pressure roller, and an endless belt. The heating temperature for this is generally 80° C. to 200° C. Note that, in combination with or instead of the fixing unit, an optical fixing unit known in the art may be used.

The diselectrification step is applying diselectrification bias to the latent electrostatic image bearing member to diselectrify the latent electrostatic image bearing member, and the diselectrification step can be carried out with the diselectrification unit. The diselectrification unit is not particularly restricted, as long as it is capable of applying diselectrification bias to the latent electrostatic image bearing member, and examples thereof include a diselectrification lamp.

The cleaning step is removing the residual toner on the latent electrostatic image bearing member, and the cleaning step can be carried out with the cleaning unit. The cleaning unit is not particularly restricted, as long as it is capable of removing the residual toner on the latent electrostatic image bearing member, and examples thereof include a magnetic brush cleaner, an electrostatic brush cleaner, a magnetic roller cleaner, a blade cleaner, a brush cleaner, and a web cleaner.

The recycling step is recycling the toner removed in the cleaning step to the developing unit, and the recycling can be performed by the recycling unit. The recycling unit is not particularly restricted, and as the recycling unit, conventional conveying units, and the like can be used.

The controlling step is controlling operation of each step, and the controlling can be performed by the controlling unit.

The controlling unit is appropriately selected depending on the intended purpose without any restriction provided that it is capable of controlling operations of each unit (i.e. each device), and examples thereof include a sequencer, and a computer.

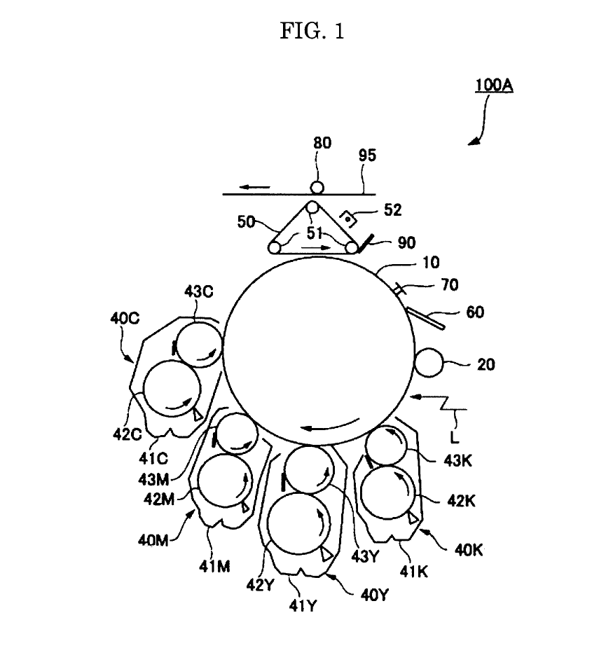

One example of the image forming apparatus of the present invention is illustrated in FIG. 1. An image forming apparatus 100A is equipped with a photoconductor drum 10 as the latent electrostatic bearing member, a charge roller 20 as the charging unit, an exposure device (not shown) as the exposing unit, a developing device 40 as the developing unit, an intermediate transfer member 50, a cleaning device having a cleaning blade 60 as the cleaning unit, and a charge eliminating lamp 70 as the diselectrification unit.

The intermediate transfer member 50 is an endless belt, and stretched around three rollers 51 placed inside the belt and designed to be moveable in the direction shown with the arrow. Part of the three rollers 51 also function as a transfer bias roller capable of applying a transfer bias (primary transfer bias), to the intermediate transfer member 50.

A cleaning unit containing a cleaning blade 90 is provided near the intermediate transfer belt 50. A transfer roller 80, which is capable of applying a transfer bias for transferring a toner image onto a recording paper 95 (secondary transfer), is provided so as to face to the intermediate transfer member 50.

In the surrounding area of the intermediate transfer member 50, a corona charger 52 for supplying an electrical charge to the toner image on the intermediate transfer member 50 is provided between contact area of the photoconductor drum 10 and the intermediate transfer member 50, and contact area of the intermediate transfer member 50 and recording paper 95.

The developing device 40 of each color of black (K), yellow (Y), magenta (M), and cyan (C) is equipped with a developer storage container 41, a developer feeding roller 42, and a developing roller 43.

In the image forming apparatus 100A, a surface of the photoconductor drum 10 is uniformly charged using the charging roller 20, and exposure light L is applied to the photoconductor drum 10 using the exposure device (not shown) to form a latent electrostatic image. Next, the latent electrostatic image formed on the photoconductor drum 10 is then developed with the toner fed from the developing device 40 to form a toner image. The toner image formed on the photoconductor drum 10 is transferred (primary transfer) onto the intermediate transfer member 50 by a voltage applied from the supporting roller 51. Moreover, charge is applied to the toner image on the intermediate transfer member 50 by a corona charger 52, and then the toner image is transferred onto the recording medium 95 (secondary transfer). The toner remained on the photoconductor drum 10 is then removed by the cleaning device 60, and the charge built up over the photoconductor drum 10 is temporarily removed by the diselectrification lamp 70.

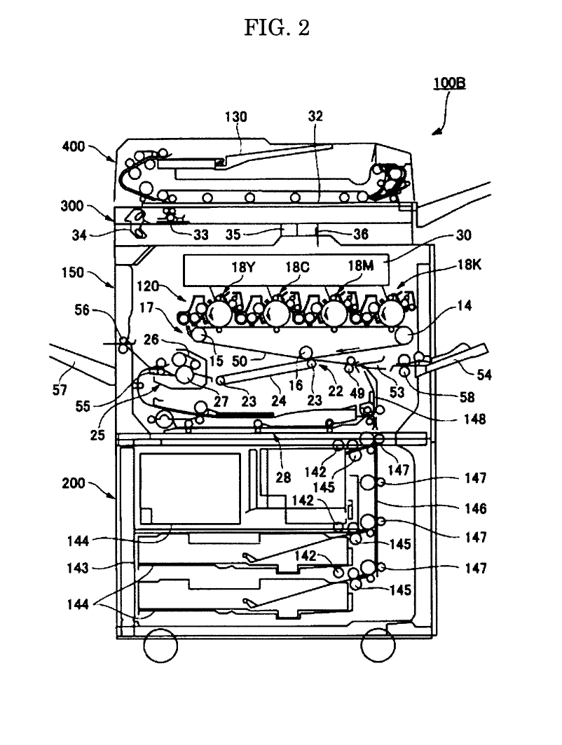

Another example of the image forming apparatus of the present invention is illustrated in FIG. 2. The image forming apparatus 100B is a tandem-type color image forming apparatus, and contains a copier main body 150, a paper feeder table 200, a scanner 300, and an automatic document feeder (ADF) 400.

To the copier main body 150, an intermediate transfer member 50 of an endless belt is provided at the center part thereof.

The intermediate transfer member 50 is stretched around three supporting rollers 14, 15, and 16 and is configured to rotate in the direction shown with the arrow.

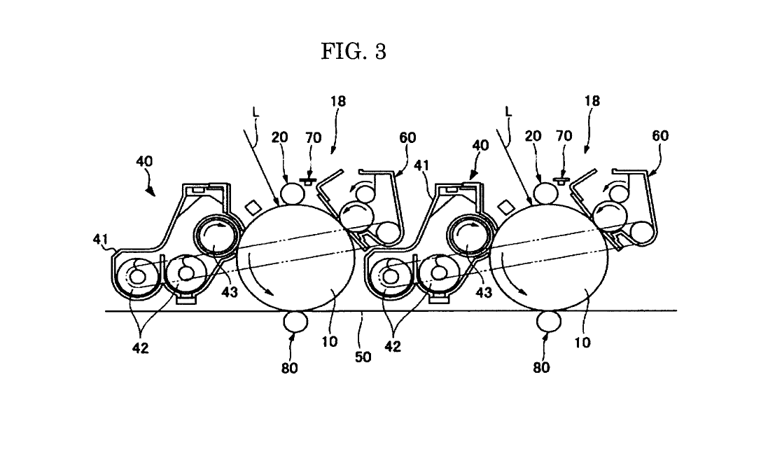

A cleaning device 17 for cleaning the residual toner on the intermediate transfer member 50 is provided adjacent to the supporting roller 15. Moreover, a tandem developing unit 120 in which four image forming units 18 including of yellow, cyan, magenta, and black (18Y, 18C, 18M, 18K) are aligned along with the rotational direction of the intermediate transfer member 50 is provided for the intermediate transfer member 50 supported with the supporting rollers 14 and 15. the image forming unit 18 of each color is, as illustrated in FIG. 3, equipped with a photoconductor drum 10, a charging roller 20 for uniformly charging the photoconductor drum 10, a developing unit 40 for developing a latent electrostatic image formed on the photoconductor drum 10 with a developer of each color of black (K), yellow (Y), magenta (M), and cyan(C) to form a toner image, a transfer roller 80 for transferring the toner image of each color onto an intermediate transfer member 50, a cleaning device 60, and a charge-eliminating lamp 70.

Moreover, the exposing device 30 is provided adjacent to the tandem-type developing unit 120 of FIG. 2. The exposing device 30 applies exposure light L onto the photoconductor drum 10 to form a latent electrostatic image thereon.

Moreover, a secondary transfer device 22 is provided to the opposite side of the intermediate transfer member 50 to the side thereof where the tandem-type developing unit 120 is provided. The secondary transfer device 22 is consisted of a secondary transfer belt 24 that is an endless belt starched around a pair of supporting rollers 23, and is configured so that recording paper conveyed on the secondary transfer belt 24 and the intermediate transfer member 50 can be in contact with each other.

A fixing device 25 is provided adjacent to the secondary transfer device 22. The fixing device 25 contains a fixing belt 26 that is an endless belt, and a pressure roller 27 provided in the manner that the pressure roller 27 is pressed against the fixing belt 26.

Furthermore, a sheet reverser 28 for reversing the recording paper for forming images on the both sides of the paper is provided near the secondary transfer device 22 and the fixing device 25.

Formation of a full-color image (color copy) by the image forming apparatus 100B will be explained next. Initially, a document is placed on a document platen 130 of the automatic document feeder (ADF) 400. Alternatively, the automatic document feeder 400 is opened, a document is placed on a contact glass 32 of the scanner 300, and the automatic document feeder 400 is closed. At the time of pushing a start switch (not shown), the document set in the automatic document feeder 400 is transported onto the contact glass 32, and then the document is scanned with a first carriage 33 and a second carriage 34. In the case where the document is initially placed on the contact glass 32, the scanner 300 is immediately driven to operate the first carriage 33 equipped and the second carriage 34 equipped. Light is applied from a light source of the first carriage 33 to the document, and reflected light from the document is further reflected at a mirror of the second carriage 34. Then, the light reflected at the mirror passes through an image forming lens 35 to reach a read sensor 36. In the manner as mentioned, the color document (color image) is read, and image information of each color of black, yellow, magenta, and cyan is obtained.

After forming a latent electrostatic image of each color on the photoconductor drum 10 by means of the exposing device 30 based on the obtained image information of each color, the latent electrostatic image of each color is developed with a developer supplied from the developing unit 40 of respective color to thereby form a toner image of each color. The formed toner images of respective colors are sequentially transferred (primary transfer) to the intermediate transfer member 50 that is rotated by rollers 14, 15, and 16 to thereby form a composite toner image on the intermediate transfer member 50.

One of feeding rollers 142 of the feeder table 200 is selectively rotated, a recording medium is ejected from one of multiple feeder cassettes 144 in a paper bank 143 and are separated by a separation roller 145 one by one into a feeder path 146, are transported by a transport roller 147 into a feeder path 148 within the main body 150 and are bumped against a registration roller 49 to stop. Alternatively, recording paper is ejected recording paper from a manual-feeding tray 54, and separated by a separation roller 58 one by one into a feeder path 53, transported one by one and then bumped against the registration roller 49. Note that, the resist roller 49 is generally earthed, but it may be biased for removing paper dust of the recording paper.

The registration roller 49 is rotated synchronously with the movement of the composite toner image on the intermediate transfer body 50 to transport the recording paper into between the intermediate transfer body 50 and the secondary transfer device 22, and the composite toner image is transferred (secondary transferred) onto the recording paper.

The recording paper onto which the composite toner image has been transferred is conveyed by the secondary transfer device 22 to introduce into a fixing device 25. In the fixing device 25, the composite toner image is heated and compressed by a fixing belt 26 and a pressure roller 27 to fix onto the recording paper. Thereafter, the recording paper changes its traveling direction by action of a switch blade 55, is ejected by an ejecting roller 56 and is stacked on an output tray 57. Alternatively, the recording paper is changed its traveling direction by action of the switch blade 55, and reversed by the sheet reverser 28, and subjected to an image formation on the back surface thereof. The recording paper bearing images on both sides thereof is then ejected with assistance of the ejecting roller 56, and is stacked on the output tray 57.

Note that the residual toner on the intermediate transfer member 50 is removed by the cleaning device 17 after the composite toner image is transferred.

### Process Cartridge

The process cartridge of the present invention is designed so that it is detachably mounted in various image forming apparatuses and contains at least a latent electrostatic image bearing member configured to bear a latent electrostatic image thereon, and a developing unit configured to develop with the developer of the present invention the latent electrostatic image on the latent electrostatic image bearing member. Note that, the process cartridge of the present invention may further contain other members, if necessary.

The developing unit contains a container in which the developer of the present invention is housed, and a developer bearing member configured to bear and convey the developer housed in the container. Note that, the developing unit may further contain a regulating member for regulating a thickness of the developer borne.

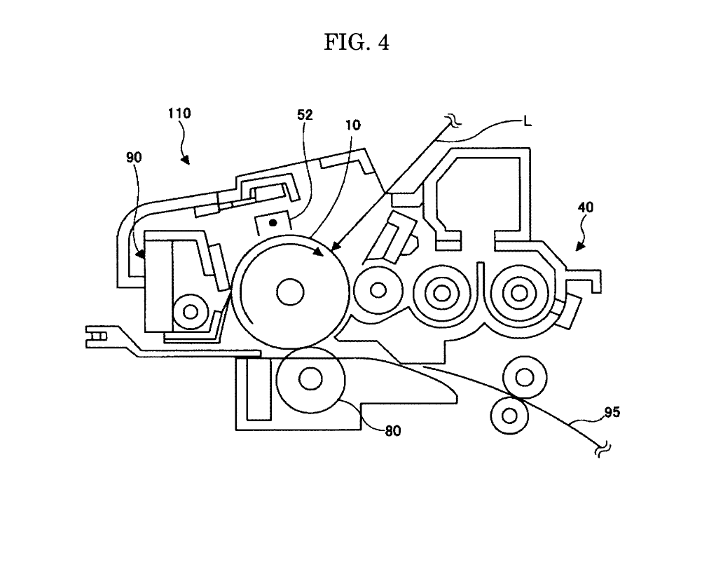

One example of the process cartridge of the present invention is illustrated in FIG. 4. The process cartridge 110 contains a photoconductor drum 10, a corona charger 52, a developing unit 40, a transfer roller 80, and a cleaning device 90.

### EXAMPLES

Examples of the present invention will be explained hereinafter, but these examples shall not be construed as limiting the scope of the present invention in any way. In the following examples, “part(s)” means “part(s) by mass.”

### <Measurement Method of Weight Average Molecular Weight of Crystalline Polyester Resin>

A weight average molecular weight of a crystalline polyester resin was measured in the following manner.

Gel permeation chromatography (GPC) measuring device:

DPC-8220GPC (Tosoh Corporation)

Column: TSKgel Super HZM-H, 15 cm, three connected columns (Tosoh Corporation)

Temperature: 40° C.

Solvent: tetrahydrofuran (THF)

Flow rate: 0.35 mL/min.

Sample: 0.4 mL of a 0.15% by mass sample solution

Pretreatment of sample: The sample was dissolved in tetrahydrofuran (THF containing a stabilizer, manufactured by Wako Chemical Industries, Ltd.) to give a concentration of 0.15% by mass, the resulting solution was then filtered through a filter having a pore size of 0.2 μm, and the filtrate from the filtration was used as a sample. The measurement was performed by supplying 100 μL of the tetrahydrofuran (THF) sample solution. For the measurement of the molecular weight of the sample, the molecular weight distribution of the sample was calculated from the relationship between the logarithmic value of the calibration curve prepared from a several monodispersible polystyrene standard samples and the number of counts. As the standard polystyrene samples for preparing the calibration curve, Showdex STANDARD Std. Nos. S-7300, S-210, S-390, S-875, S-1980, S-10.9, S-629, S-3.0, and S-0.580 of SHOWA DENKO K.K., and toluene were used. As the detector, a refractive index (R1) detector was used.

### <Melting Point of Crystalline Polyester Resin>

A melting point of a crystalline polyester resin is measured by pulverizing the polyester resin into a powder, placing the powder in a capillary tube one end of which has been closed, and elevating the temperature thereof up to the temperature at which the powder was dissolved and turned into completely clear in color in accordance with Standard Method for Analysis of Fats (2.2.4.1-1996).

### Preparation Example 1

### Synthesis of Crystalline Polyester Resin 1

A 5 L four-neck flask equipped with a nitrogen-introducing pipe, a drainpipe, a stirrer and a thermocouple was charged with 2,500 g of 1,12-decanediol, 2,330 g of 1,8-octanedioic acid, and 4.9 g of hydroquinone, and the mixture was allowed to react at 180° C. for 20 hours. Subsequently, the mixture was heated to 200° C. and allowed to react for 6 hours, followed by reacting for 10 hours at 8.3 kPa to thereby obtain Crystalline Polyester Resin 1. The thermal properties (melting point) measured by DSC, and the weight average molecular weight (Mw) measured by GPC of the obtained Crystalline Polyester Resin 1 are shown in Table 1.

### Preparation Example 2

### Synthesis of Crystalline Polyester Resin 2

A 5 L four-neck flask equipped with a nitrogen-introducing pipe, a drainpipe, a stirrer and a thermocouple was charged with 2,500 g of 1,12-decanediol, 1,930 g of 1,8-octanedioic acid, 300 g of fumaric acid, and 4.9 g of hydroquinone, and the mixture was allowed to react at 180° C. for 16 hours. Subsequently, the mixture was heated to 200° C. and allowed to react for 8 hours, followed by reacting for 9 hours at 8.3 kPa to thereby obtain Crystalline Polyester Resin 2. The thermal properties (melting point) measured by DSC, and the weight average molecular weight (Mw) measured by GPC of the obtained Crystalline Polyester Resin 2 are shown in Table 1.

### Preparation Example 3

### Synthesis of Crystalline Polyester Resin 3

A 5 L four-neck flask equipped with a nitrogen-introducing pipe, a drainpipe, a stirrer and a thermocouple was charged with 2,500 g of 1,12-decanediol, 2,330 g of 1,8-octanedioic acid, and 6.9 g of hydroquinone, and the mixture was allowed to react at 180° C. for 10 hours. Subsequently, the mixture was heated to 200° C. and allowed to react for 4 hours, followed by reacting for 5 hours at 8.3 kPa to thereby obtain Crystalline Polyester Resin 3. The thermal properties (melting point) measured by DSC, and the weight average molecular weight (Mw) measured by GPC of the obtained Crystalline Polyester Resin 3 are shown in Table 1.

### Preparation Example 4

### Synthesis of Crystalline Polyester Resin 4

A 5 L four-neck flask equipped with a nitrogen introducing pipe, a drainpipe, a stirrer and a thermocouple was charged with 2,160 g of fumaric acid, 2,320 g of 1,6-hexanediol, and 3.9 g of hydroquinone, and the mixture was allowed to react at 180° C. for 15 hours. Subsequently, the mixture was heated to 200° C. and allowed to react for 5 hours, followed by reacting for 4 hours at 8.3 kPa to thereby obtain Crystalline Polyester Resin 4. The thermal properties (melting point) measured by DSC, and the weight average molecular weight (Mw) measured by GPC of the obtained Crystalline Polyester Resin 4 are shown in Table 1.

### Preparation Example 5

### Synthesis of Crystalline Polyester Resin 5

A 5 L four-neck flask equipped with a nitrogen-introducing pipe, a drainpipe, a stirrer and a thermocouple was charged with 2,500 g of 1,12-decanediol, 2,330 g of 1,8-octanedioic acid, and 10.9 g of hydroquinone, and the mixture was allowed to react at 180° C. for 6 hours. Subsequently, the mixture was heated to 200° C. and allowed to react for 3 hours, followed by reacting for 4 hours at 8.3 kPa to thereby obtain Crystalline Polyester Resin 5. The thermal properties (melting point) measured by DSC, and the weight average molecular weight (Mw) measured by GPC of the obtained Crystalline Polyester Resin 5 are shown in Table 1.

TABLE 1

| | Melting point (° C.) | Mw |
|---|---|---|
| Crystalline Polyester Resin 1 | 70 | 15,000 |
| Crystalline Polyester Resin 2 | 78 | 12,200 |
| Crystalline Polyester Resin 3 | 61 | 10,400 |
| Crystalline Polyester Resin 4 | 93 | 11,600 |
| Crystalline Polyester Resin 5 | 58 | 9,720 |

### Preparation Example 6

### Synthesis of Non-Crystalline Polyester (Low Molecular Weight Polyester)

### Resin

A 5 L four-neck flask equipped with a nitrogen-introducing pipe, a drainpipe, a stirrer and a thermocouple was charged with 229 parts of bisphenol A ethylene oxide 2 mole adduct, 529 parts of bisphenol A propylene oxide 3 mole adduct, 100 parts of isophthalic acid, 108 parts of terephthalic acid, 46 parts of adipic acid and 2 parts of dibutyl tin oxide. The mixture was allowed to react for 10 hours at 230° C. under normal pressure, and further reacted for another 5 hours under reduced pressure of 10 mmHg to 15 mmHg. After the reaction, 30 parts of trimellitic anhydride was added to the reaction container, and the mixture was allowed to react for 3 hours at 180° C. under normal pressure to thereby obtain Non-Crystalline Polyester Resin 1.

The obtained Non-Crystalline Polyester Resin 1 had a number average molecular weight of 1,800, weight average molecular weight of 5,500, glass transition temperature (Tg) of 50° C., and acid value of 20 mgKOH/g.

### Example 1

### Dissolution Suspension Method

### Synthesis of Polyester Prepolymer

A reaction container equipped with a condenser, a stirrer and a nitrogen-introducing pipe was charged with 682 parts of bisphenol A ethylene oxide 2 mole adduct, 81 parts of bisphenol A propylene oxide 2 mole adduct, 283 parts of terephthalic acid, 22 parts of trimellitic anhydride and 2 parts of dibutyl tin oxide. The resultant mixture was allowed to react under normal pressure at 230° C. for 8 hours and further react at a reduced pressure of 10 mmHg to 15 mmHg for 5 hours, to thereby produce Intermediate Polyester 1. The obtained Intermediate Polyester 1 had a number average molecular weight of 2,100, weight average molecular weight of 9,500, Tg of 55° C., acid value of 0.5 mgKOH/g and hydroxyl value of 51 mgKOH/g.

Next, a reaction container equipped with a condenser, a stirrer and a nitrogen-introducing pipe was charged with 410 parts of Intermediate Polyester 1, 89 parts of isophorone diisocyanate and 500 parts of ethyl acetate, followed by reaction at 100° C. for 5 hours, to thereby produce Prepolymer 1.

The amount of free isocyanate contained in Prepolymer 1 was 1.53% by mass.

### Synthesis of Ketimine

A reaction container equipped with a stirring rod and a thermometer was charged with 170 parts of isophorone diisocyanate and 75 parts of methyl ethyl ketone, followed by reaction at 50° C. for 5 hours, to thereby produce Ketimine Compound 1. The amine value of Ketimine Compound 1 was 418.

### Synthesis of Master Batch (MB)

Water (1,200 parts), carbon black (Printex 35, product of Degussa) [DBP oil absorption amount=42 mL/100 mg, pH=9.5] (540 parts) and Non-Crystalline Polyester 1 (1,200 parts) were mixed together with HENSCHEL MIXER (product of Mitsui Mining Co., Ltd). The resultant mixture was kneaded at 150° C. for 30 minutes with a two-roller mill, and then rolled, cooled and pulverized with a pulverizer, to thereby produce Masterbatch 1.

### Preparation of Crystalline Polyester Dispersion Liquid

A 2 L-metal container was charged with 100 g of Crystalline Polyester Resin 1 and 400 g of ethyl acetate, followed by heating at 70° C. for dissolution. Thereafter, the resultant mixture was quenched in an iced-water bath at the rate of 20° C./min. After the resulting dispersion liquid was cooled, 100 g of Non-Crystalline Polyester Resin 1 was added thereto and made dissolved therein. Then, glass beads (3 mm in diameter) (500 mL) were added to the mixture to perform pulverization with a batch-type sand mill (manufactured by Kanpe Hapio Co., Ltd.) at the average fluid temperature of 20° C. or lower for 10 hours, to thereby produce Crystalline Polyester Dispersion Liquid 1 having the volume average particle diameter of 0.3 μm.

### Preparation of Oil Phase

A container equipped with a stirring rod and a thermometer was charged with 378 parts of Non-Crystalline Polyester 1, 110 parts of microcrystalline wax (Hi-Mic-1090, manufactured by Nippon Seiro Co., Ltd.), 22 parts of a charge controlling agent (CCA) (salycilic acid metal complex E-84, manufactured by Orient Chemical Industries, Ltd.) and 947 parts of ethyl acetate, and the mixture was heated to 80° C. under stirring. The resultant mixture was maintained at 80° C. for 5 hours and then cooled to 30° C. over 1 hour. Subsequently, the reaction container was charged with 500 parts of the masterbatch and 500 parts of ethyl acetate, followed by mixing the mixture for 1 hour, to thereby prepare Raw Material Solution 1.

The obtained Raw Material Solution 1 (1,324 parts) was poured into a container, and the carbon black and wax were dispersed with a bead mill (ULTRA VISCOMILL, manufactured by AIMEX CO., Ltd.) under the following conditions: a liquid feed rate of 1 kg/hr, disc circumferential velocity of 6 m/s, 0.5 mm-zirconium beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 1

The solid content of Pigment-Wax Dispersion Liquid 1 was 50% by mass (130° C., 30 minutes).

### Synthesis of Organic Particle Emulsion

A reaction container equipped with a stirring rod and a thermometer was charged with 683 parts of water, 11 parts of a sodium salt of sulfuric acid ester of methacrylic acid-ethylene oxide adduct (ELEMINOL RS-30, manufactured by Sanyo Chemical Industries, Ltd.), 138 parts of styrene, 138 parts of methacrylic acid and 1 part of ammonium persulfate, and the resultant mixture was stirred at 400 rpm for 15 minutes to prepare a white emulsion. The obtained emulsion was heated to the internal system temperature of 75° C. and allowed to react for 5 hours. Subsequently, a 1% by mass aqueous ammonium persulfate solution (30 parts) was added to the reaction mixture, followed by aging at 75° C. for 5 hours, to thereby prepare an aqueous dispersion liquid (Fine Particle Dispersion Liquid 1) of a vinyl resin (a copolymer of styrene/methacrylic acid/sodium salt of sulfuric acid ester of methacrylic acid ethylene oxide adduct).

The prepared Fine Particle Dispersion Liquid 1 was measured for volume average particle diameter with a particle size distribution analyzer (LA-920, manufactured by Horiba, Ltd.), and was found to have a volume average particle diameter of 0.14 p.m.

Part of Fine Particle Dispersion Liquid 1 was dried to separate resin.

### Preparation of Aqueous Phase

Water (990 parts), 83 parts of Fine Particle Dispersion Liquid 1, 37 parts of a 48.5% aqueous solution of sodium dodecyldiphenyl ether disulfonate (ELEMINOL MON-7, product of Sanyo Chemical Industries Ltd.) and 90 parts of ethyl acetate were mixed together and stirred to obtain an opaque white liquid, which was used as Aqueous Phase 1.

### Emulsification, Removal of Solvent (De-Solvent)

In a container, 664 parts of Pigment-Wax Dispersion Liquid 1, 109.4 parts of Prepolymer 1, 73.9 parts of Crystalline Polyester Dispersion Liquid 1 and 4.6 parts of Ketimine Compound 1 were placed, followed by mixing for 1 minute at 5,000 rpm with a TK homomixer (manufactured by Tokushu Kika Kogyo Co., Ltd.). Thereafter, 1,200 parts of Aqueous Phase 1 was added to the container, and the resultant mixture was mixed with the TK homomixer at 11,000 rpm for 5 minutes, to thereby produce Emulsified Slurry 1.

A container equipped with a stirrer and a thermometer was charged with Emulsified Slurry 1, followed by desolvation at 30° C. for 8 hours and aging at 45° C. for 4 hours, to thereby produce Dispersion Slurry 1.

### Washing, Drying

Dispersion Slurry 1 (100 parts) was filtrated under reduced pressure and then subjected a series of treatments (1) to (4) described below:

(1): ion-exchanged water (100 parts) was added to the filtration cake, followed by mixing with a TK homomixer (at 12,000 rpm for 10 minutes) and then filtration;

(2): 10% aqueous sodium hydroxide solution (100 parts) was added to the filtration cake obtained in (1), followed by mixing with a TK homomixer (at 12,000 rpm for 30 minutes) and then filtration under reduced pressure;

(3): 10% hydrochloric acid (100 parts) was added to the filtration cake obtained in (2), followed by mixing with a TK homomixer (at 12,000 rpm for 10 minutes) and then filtration; and

(4): ion-exchanged water (300 parts) was added to the filtration cake obtained in (3), followed by mixing with a TK homomixer (at 12,000 rpm for 10 minutes) and then filtration, and this operation was performed twice, to thereby produce Filtration Cake 1.

Filtration Cake 1 was dried with an air-circulating drier at 45° C. for 48 hours, and then was passed through a sieve with a mesh size of 75 μm, to thereby prepare toner base particles.

To obtained toner base particles (100 parts), 0.7 parts of hydrophobic silica, and 0.3 parts of hydrophobic titanium oxide were mixed by means of HENSCHEL MIXER to thereby obtain Toner 1.

### Example 2

Toner 2 was prepared in the same manner as in Example 1, provided that a crystalline polyester dispersion liquid was prepared by using Crystalline Polyester Resin 2 instead of Crystalline Polyester Resin 1

### Example 3

Toner 3 was prepared in the same manner as in Example 1, provided that a crystalline polyester dispersion liquid was prepared by using Crystalline Polyester Resin 3 instead of Crystalline Polyester Resin 1.

### Example 4

A 2 L-metal container was charged with 100 g of Crystalline Polyester Resin 1 and 400 g of ethyl acetate, followed by heating at 70° C. for dissolution. Thereafter, the resultant mixture was quenched in an iced-water bath at the rate of 20° C./min. After the resulting dispersion liquid was cooled, 100 g of Non-Crystalline Polyester Resin 1 was added thereto and made dissolved therein. Then, glass beads (3 mm in diameter) (500 mL) were added to the mixture to perform pulverization with a batch-type sand mill (product of Kanpe Hapio Co., Ltd.) at the average fluid temperature of 24° C. or lower for 10 hours, to thereby produce Crystalline Polyester Dispersion Liquid 2 having the volume average particle diameter of 0.3 μm.

Toner 4 was obtained in the same manner as Example 1, provided that Crystalline Polyester Dispersion Liquid 2 was used instead of Crystalline Polyester Dispersion Liquid 1.

### Comparative Example 1

A 2 L-metal container was charged with 100 g of Crystalline Polyester Resin 1 and 400 g of ethyl acetate, followed by heating at 70° C. for dissolution. Thereafter, the resultant mixture was quenched in an iced-water bath at the rate of 20° C./min. After the resulting dispersion liquid was cooled, 100 g of Non-Crystalline Polyester Resin 1 was added thereto and made dissolved therein. Then, glass beads (3 mm in diameter) (500 mL) were added to the mixture to perform pulverization with a batch-type sand mill (product of Kanpe Hapio Co., Ltd.) at the average fluid temperature of 28° C. or lower for 10 hours, to thereby produce Crystalline Polyester Dispersion Liquid 3 having the volume average particle diameter of 0.3 μm.

Toner 7 was obtained in the same manner as Example 1, provided that Crystalline Polyester Dispersion Liquid 3 was used instead of Crystalline Polyester Dispersion Liquid 1.

### Comparative Example 2

Toner 8 was prepared in the same manner as in Example 1, provided that a crystalline polyester dispersion liquid was prepared by using Crystalline Polyester Resin 4 instead of Crystalline Polyester Resin 1.

### Comparative Example 3

Toner 9 was prepared in the same manner as in Example 1, provided that a crystalline polyester dispersion liquid was prepared by using Crystalline Polyester Resin 5 instead of Crystalline Polyester Resin 1.

### Example 5

### Pulverization Method

### Formulation of Raw Materials

Binder resin: Crystalline Polyester Resin 1 (8 parts)
Binder resin: Non-Crystalline Polyester Resin 1 (86 parts)
Colorant: Carbon black C-44, manufactured by Mitsubishi Chemical Corporation, having the average particle diameter of 24 nm, and BET specific surface area of 125 m²/g (7 parts)
Charge controlling agent (CCA): BONTRON E-84, manufactured by Orient Chemical Industries Co., Ltd. (1 part)
Wax: Hi-mic-1090, manufactured by Nippon Seiro Co., Ltd. (6 parts)

The toner powder raw materials mentioned above were sufficiently mixed by means of a super mixer (SMV-200, manufactured by KAWATA MFG Co. Ltd.), to thereby obtain a toner powder raw material mixture. This toner powder raw material mixture was supplied to Buss cokneader (TCS-100, Buss) through a raw material supplying hopper, and was kneaded at the feeding rate of 120 kg/h.

The obtained kneaded product was rolled and cooled, and then roughly grinded by a hammer mill, followed by fine grinding by means of jet flow grinder (I-20 Jet Mill, manufactured by Nippon Pneumatic Mfg. Co., Ltd.). Thereafter, the resultant was subjected to classification of a fine powder by means of a wind classifier (DS-20, DS-10 separator, manufactured by Nippon Pneumatic Mfg. Co., Ltd.). Then, the obtained product from the classification was left to stand for 24 hours at 50° C. for annealing.

The obtained toner (100 parts) in the manner was mixed with 0.7 parts of hydrophobic silica, and 0.3 parts of hydrophobic titanium oxide, and the mixture was mixed by HENSCHEL MIXER to thereby obtain Toner 5.

### Example 6

Toner 6 was obtained in the same manner as in Example 5, provided that the annealing was performed at 30° C. for 24 hours.

### Comparative Example 4

Toner 12 was prepared in the same manner as in Example 5, provided that the annealing was not performed.

### Comparative Example 6

Toner 14 was obtained in the same manner as in Example 5, provided that a crystalline polyester dispersion liquid was prepared by using Crystalline Polyester Resin 4 instead of Crystalline Polyester Resin 1.

### Comparative Example 8

Toner 16 was obtained in the same manner as in Example 5, provided that a crystalline polyester dispersion liquid was prepared by using Crystalline Polyester Resin 5 instead of Crystalline Polyester Resin 1.

### Example 7

### Emulsification Aggregation Method

### Preparation of Crystalline Polyester Dispersion Liquid 4

A stainless steel beaker was charged with 180 parts of Crystalline Polyester Resin 1, and 585 parts of deionized water, and the mixture was heated to 95° C. by placing the beaker in a hot bath.

When Crystalline Polyester Resin 1 was dissolved in water and the solution became clear, a 1% ammonium water was added to the solution to adjust pH thereof to 7.0 while stirring at 10,000 rpm by means of T.K. ROBOMIX (manufactured by PRIMIX Corporation). Subsequently, emulsification dispersion was performed by adding 0.8 parts of an anionic surfactant (NEOGEN R-K, manufactured by Dai-ichi Kogyo Seiyaku Co., Ltd.), and 0.2 parts of a nonionic emulsifier (EMULGEN 950, manufactured by Kao Corporation) to 20 parts of the diluted aqueous solution dropwise, to thereby Prepare Crystalline Polyester Dispersion Liquid 4 (solid content: 11.9% by mass) having the volume average particle diameter of 0.22 μm.

### Preparation of Non-Crystalline Polyester Dispersion Liquid

Non-Crystalline Polyester Dispersion Liquid 1 (solid content: 12.3% by mass) was prepared in the same manner as in preparation of Crystalline Polyester Dispersion Liquid 4, provided that Crystalline Polyester Resin 1 was replaced with Non-Crystalline Polyester Resin 1.

### Preparation of Pigment Dispersion Liquid

A container was charged with 20 parts of carbon black (MA100S, manufactured by Mitsubishi Chemical Corporation), 80 parts of ion-exchanged water, and 4.0 parts of an anionic surfactant (NEOGEN R-K, manufactured by Dai-ichi Kogyo Seiyaku Co., Ltd.), and the pigment (carbon black) was dispersed therein by means of a bead mill (ULTRA VISCOMILL, manufactured by AIMEX CO., Ltd.) under the following conditions: a liquid feed rate of 1 kg/hr, disc circumferential velocity of 6 m/s, 0.3 mm-zirconium beads packed to 80% by volume, and 15 passes, to thereby obtain Pigment Dispersion Liquid 1 (solid content: 19.8% by mass) having the volume average particle diameter of 0.07 μm.

### Preparation of Wax Dispersion Liquid

Wax (Hi-mic-1090, Nippon Seiro Co., Ltd.) (20 parts), 80 parts of ion-exchanged water, and 4 parts of an anionic surfactant (NEOGEN R-K, manufactured by Dai-ichi Kogyo Seiyaku Co., Ltd.), and the mixture was heated at 95° C. for 1 hour while stirring. Thereafter, the resultant was cooled, and the wax was dispersed therein by means of a bead mill (ULTRA VISCOMILL, manufactured by AIMEX CO., Ltd.) under the following conditions: a liquid feed rate of 1 kg/hr, disc circumferential velocity of 6 m/s, 0.3 mm-zirconium beads packed to 80% by volume, and 25 passes, to thereby prepare Wax Dispersion Liquid 1 (solid content: 20.8% by mass) having the volume average particle diameter of 0.15 μm.

### Preparation of Charge Controlling Agent (CCA) Dispersion Liquid

A container was charged with 5 parts of a charge controlling agent (CCA) (BONTRON E-84, manufactured by Orient Chemical Industries Co., Ltd.), 95 parts of ion-exchanged water, and 0.5 parts of an anionic surfactant (NEOGEN R-K, manufactured by Dai-ichi Kogyo Seiyaku Co., Ltd.), and the charge controlling agent was dispersed thereby by means of a bead mill (ULTRA VISCOMILL, manufactured by AIMEX CO., Ltd.) under the following conditions: a liquid feed rate of 1 kg/hr, disc circumferential velocity of 6 m/s, 0.3 mm-zirconium beads packed to 80% by volume, and 5 passes, to thereby obtain Charge Controlling Agent (CCA) Dispersion Liquid 1 (solid content: 4.8% by mass).

### Preparation Method of Toner

The following components were mixed and stirred for 2 hours at 25° C. by means of a disperser.

| | |
|---|---|
| Pigment Dispersion Liquid 1 | 35.4 parts |
| CCA Dispersion Liquid 1 | 20.8 parts |
| Crystalline Polyester Dispersion Liquid 4 | 67.2 parts |
| Non-Crystalline Polyester Dispersion Liquid 1 | 634.1 parts |
| Wax Dispersion Liquid 1 | 28.8 parts |

The resulting dispersion liquid was heated up to 50° C., and the pH thereof was adjusted to 7.0 with ammonium. Then, the dispersion liquid was further heated to 72° C., and the temperature was maintained for 6 hours (annealing), to thereby obtain Dispersion Slurry 2.

Dispersion Slurry 2 (100 parts) was filtrated under reduced pressure and then subjected a series of treatments (1) to (3) described below:

(1): ion-exchanged water (100 parts) was added to the filtration cake, followed by mixing with a TK homomixer (at 12,000 rpm for 10 minutes) and then filtration;

(2): 10% hydrochloric acid was added to the filtration cake obtained in (1) to adjust the pH thereof to 2.8, followed by mixing with a TK homomixer (at 12,000 rpm for 10 minutes) and then filtration; and

(3): ion-exchanged water (300 parts) was added to the filtration cake obtained in (2), followed by mixing with a TK homomixer (at 12,000 rpm for 10 minutes) and then filtration, and this operation was performed twice, to thereby produce Filtration Cake 2.

Filtration Cake 2 was dried with an air-circulating drier at 45° C. for 48 hours, and then was passed through a sieve with a mesh size of 75 μm, to thereby prepare toner base particles having the volume average particle diameter of 5.9 μm. To the obtained toner base particles (100 parts), 0.5 parts of a fluidity enhancer, R972 (silica of Nippon Aerosil Co., Ltd., the average primary particle diameter of 0.016 μm) was externally added to thereby obtain Toner 6.

### Example 8

Toner 8 was obtained in the same manner as in Example 7, provided that the annealing was performed at 30° C. for 24 hours.

### Comparative Example 5

Toner 13 was obtained in the same manner as in Example 7, provided that the annealing was not performed.

### Comparative Example 7

Toner 15 was obtained in the same manner as in Example 7, provided that a crystalline polyester dispersion liquid was prepared by using Crystalline Polyester Resin 4 instead of Crystalline Polyester Resin 1.

### Comparative Example 9

Toner 17 was obtained in the same manner as in Example 7, provided that a crystalline polyester dispersion liquid was prepared by using Crystalline Polyester Resin 5 instead of Crystalline Polyester Resin 1.

### Preparation of Carrier

To 100 parts of toluene, 100 parts of a silicone resin (organostraight silicone), 5 parts of γ-(2-aminoethyl)aminopropyltrimethoxysilane, and 10 parts of carbon black were added, and the mixture was dispersed by means of a homomixer for 20 minutes, to thereby prepare a resin layer coating liquid.

The obtained resin layer coating liquid was applied to surfaces of spherical magnetite particles (1,000 parts) having the average particle diameter of 50 μm by means of a fluid bed coating device, to thereby prepare a carrier.

### Preparation of Developer

By means of a ball mill, 5 parts of the toner and 95 parts of the carrier were mixed to prepare a developer.

### Evaluation Methods and Results

The obtained developer was evaluated in the following manners. The evaluation results are shown in Table 2.

### Fixing Ability

The fixing portion of the copier (MF-2200, manufactured by Ricoh Company, Ltd.) employing a TEFLON (registered trade mark) roller as a fixing roller was modified to produce a modified copier. The above-produced developer and Type 6200 paper sheets (product of Ricoh Company, Ltd.) were set in the modified copier for printing test.

Specifically, the cold offset temperature (minimum fixing temperature) was determined while changing the fixing temperature.

The evaluation conditions for the minimum fixing temperature were set as follows: linear velocity of paper feeding: 120 mm/sec to 150 mm/sec, surface pressure: 1.2 kgf/cm² and nip width: 3 mm.

The evaluation conditions for the maximum fixing temperature were set as follows: linear velocity of paper feeding: 50 mm/sec, surface pressure: 2.0 kgf/cm² and nip width: 4.5 mm.

The lower the minimum fixing temperature is more preferable as the power consumption reduces, and the minimum fixing temperature of 130° C. or lower is an acceptable level in actual practice, without any problem.

The evaluation criteria were as follow:

A: The minimum fixing temperature was lower than 125° C.
B: The minimum fixing temperature was 125° C. to 130° C.
C: The minimum fixing temperature was around 130° C., but cold offset occurred.
D: The minimum fixing temperature was higher than 130° C.

### Heat Resistant Storage Stability

A 50 mL-glass container was filled with the toner, and left in a thermostat of 50° C. for 24 hours, followed by cooling to 24° C. The toner was then subjected to the measurement of a penetration degree in accordance with a penetration degree test as prescribed in JIS K2235-1991, and evaluated in terms of heat resistant storage stability thereof.

Note that, the penetration degree of 25 mm or more was determined as A; the penetration degree of 15 mm or more, but less than 25 mm was determined as B; the penetration degree of 5 mm or more, but less than 15 mm was determined as C; and the penetration degree of less than 5 mm was determined as D, as rankings for the evaluation.

It means that the larger the penetration degree is, more excellent the heat resistant storage stability is. The toner giving the penetration degree of less than 5 mm has the possibility of causing problems upon use.

### Image Evaluation

A supply bottle was filled with the toner, and stored at 30° C. and 60% RH for 4 weeks. The developer and the toner supply bottle were used for continuous printing of a solid image for 100 pieces, by means of Imagio Neo 450 of Ricoh Company Limited, which could output 45 sheets (A4 size) per minute. The resulting images were evaluated based on the following criteria.

### [Evaluation Criteria]

A: Uniform and excellent solid image.
B: White line in the width of less than 0.3 mm was slightly observed, but it was not clearly shown in the solid image.
C: White line(s) in the width of 0.3 mm or more was observed, and white line was observed in the solid image on less than 20 sheets out of 100 sheets.
D: White line(s) in the width of 0.3 mm or more was observed, and white line was observed in the solid image on 20 sheets or more out of 100 sheets.

TABLE 2

| | | | | | Lowest | | Image |
|---|---|---|---|---|---|---|---|
| | Toner | | | (W1 − W1′)/ | limit of | Storage | evalua- |
| | No. | W1 | W1′ | W1 | fixing | stability | tion |
| Ex. 1 | 1 | 5.9 | 4.9 | 0.17 | A | A | A |
| Ex. 2 | 2 | 5.3 | 4.6 | 0.13 | B | A | A |
| Ex. 3 | 3 | 6.8 | 5.6 | 0.18 | A | A | B |
| Ex. 4 | 4 | 7.1 | 3.9 | 0.45 | A | B | B |
| Ex. 5 | 5 | 6.4 | 4.1 | 0.36 | A | A | B |
| Ex. 6 | 6 | 6.1 | 3.1 | 0.49 | B | B | A |
| Ex. 7 | 7 | 6.9 | 5.6 | 0.19 | A | B | A |
| Ex. 8 | 8 | 6.0 | 3.1 | 0.49 | B | B | A |
| Comp. | 9 | 13.2 | 4.3 | 0.67 | B | C | D |
| Ex. 1 | | | | | | | |
| Comp. | 10 | 5.8 | 5.0 | 0.14 | C | A | C |
| Ex. 2 | | | | | | | |
| Comp. | 11 | 7.3 | 5.2 | 0.29 | B | C | C |
| Ex. 3 | | | | | | | |
| Comp. | 12 | 11.8 | 4.6 | 0.61 | B | D | C |
| Ex. 4 | | | | | | | |
| Comp. | 13 | 12.8 | 4.3 | 0.66 | B | D | C |
| Ex. 5 | | | | | | | |
| Comp. | 14 | 5.3 | 5.1 | 0.04 | D | B | B |
| Ex. 6 | | | | | | | |
| Comp. | 15 | 5.2 | 4.4 | 0.15 | D | B | B |
| Ex. 7 | | | | | | | |
| Comp. | 16 | 6.9 | 3.5 | 0.49 | B | D | C |
| Ex. 8 | | | | | | | |
| Comp. | 17 | 6.7 | 3.4 | 0.49 | B | D | C |
| Ex. 9 | | | | | | | |

From the results shown in Table 2, it was found that the toner of Examples which satisfied the relationship of (W1−W1′)/W1<0.50 was excellent in fixing ability, heat resistance storage stability, and image quality.

Since the crystalline polyester resin used in Example 2 had the higher melting point than that of Example 1, the low temperature fixing ability of Example 2 was lower than that of Example 1. Since the crystalline polyester resin of low melting point was used in Example 3, the toner of Example 3 had excellent low temperature fixing ability, but slightly low heat resistant storage stability.

As the temperature of the dispersion liquid increased during the preparation of the crystalline polyester resin dispersion liquid in Example 4, the crystalline polyester resin and the non-crystalline polyester resin were partly melted together. Therefore, the toner of Example 4 had slightly poorer heat resistant storage stability and higher maximum fixing temperature compared to that of Example 1.

In Examples 5 and 7, the toners thereof were prepared in the pulverization method, and the emulsification aggregation method, respectively. The toners obtained in the both methods had the similar levels of the fixing ability, heat resistant storage stability, and excellent image quality to those of Example 1.

In Examples 6 and 8, the toners thereof were prepared in the pulverization method, and the emulsification aggregation method, respectively. The toners obtained in the both methods had desirable fixing ability and heat resistant storage stability, and excellent image quality even through the temperature of the annealing was low.

Since the temperature of the dispersion liquid increased more during the preparation of the crystalline polyester resin dispersion liquid in Comparative Example 1 than that in Example 4, large part of the crystalline polyester resin and the non-crystalline polyester resin were melted together. Therefore, the resulting toner had higher maximum fixing temperature, and poor heat resistant storage stability and image quality.

In Comparative Example 2, the crystalline polyester resin used had the high melting point, and thus the effect of melting the crystalline polyester resin and the non-crystalline polyester resin by the heat applied during fixing was not attained. Therefore, the low temperature fixing ability of the toner was poor. In Comparative Example 3, the crystalline polyester resin used had low melting point, which lowered the glass transition temperature of the toner. Therefore, the toner had poor heat heat resistant storage stability.

In Comparative Examples 4 and 5, annealing was not performed on the toner, and thus recrystallization of the crystalline polyester resin was not progressed, which leaded poor heat resistant storage stability and image quality.

In Comparative Examples 6 and 7, the crystalline polyester resin used satisfied the relationship of (W1−W1′)/W1<0.50, but had a high melting point, and therefore the fixing ability of the toner was poor.

In Comparative Examples 8 and 9, the crystalline polyester resin having a low melting point was used, and therefore the heat resistant storage stability of the toner was poor, though the fixing ability thereof was relatively good.

As described above, the present invention can provide a toner, which gives excellent low temperature fixing ability and desirable offset resistance, and can form images having desirable sharpness and of high quality for a long period of time without smearing a fixing device and images, as well as providing a developer containing the toner, a developer container housing the developer therein, a process cartridge, an image forming apparatus and an image forming method.

This application claims priority to Japanese application No. 2 010-190272, filed on Aug. 27, 2010, and incorporated herein by reference.

What is claimed is:

1. A toner, comprising:
a crystalline polyester resin; and
a non-crystalline polyester resin,
wherein the crystalline polyester resin has a melting point of 60° C. to 80° C., and
wherein the toner satisfies the relationship represented by the following formula:
(W1−W1′)/W1<0.50
where W1 is a temperature width at a 1/3 height of a height of an endothermic peak of the crystalline polyester resin on a differential scanning calorimetry curve of the toner at the time of an initial temperature elevation as measured by differential scanning calorimetry, and W1′ is a temperature width at a 1/3 height of a height of an endothermic peak of the crystalline polyester resin on a differential scanning calorimetry curve of the toner measured after the toner has been heated at 50° C. for 24 hours.

2. The toner according to claim 1, wherein the toner is obtainable by the method containing:
emulsifying or dispersing a dispersion liquid in an aqueous medium, the dispersion liquid containing an organic solvent, and toner materials including at least a binder resin and a releasing agent dissolved or dispersed in the organic solvent; and
removing the organic solvent.

3. The toner according to claim 2, wherein the binder resin contained in the dispersion liquid contains a binder resin precursor.

4. The toner according to claim 2, wherein the dispersion liquid is an oil phase in which at least a colorant, the releasing agent, the crystalline polyester resin, a compound containing an active hydrogen group, and a binder resin precursor having a portion capable of reacting with the compound containing an active hydrogen group are dissolved or dispersed in the organic solvent, and the aqueous medium contains a dispersant therein,
wherein the emulsifying or dispersing contains dispersing the oil phase in the aqueous medium to obtain an emulsified dispersion liquid and allowing the binder resin precursor to react with the compound containing an active hydrogen group in the emulsified dispersion liquid, and
wherein the removing contains removing the organic solvent from the emulsified dispersion liquid.

5. The toner according to claim 1, wherein the toner is obtained by the method containing:
melting and kneading toner materials containing at least the crystalline polyester resin and the non-crystalline polyester resin;
pulverizing the kneaded product; and
classifying the pulverized product.

6. The toner according to claim 5, further comprising:
carrying out annealing at the temperature lower than the temperature of the endothermic peak of the crystalline polyester resin by 5° C. to 15° C., before or after the classifying.

7. The toner according to claim 1, wherein the toner is obtained by the method containing:
dispersing the crystalline polyester resin and the non-crystalline polyester resin respectively in a separate aqueous media to emulsify the crystalline polyester resin and the non-crystalline polyester resin as crystalline polyester resin particles, and non-crystalline polyester particles, respectively;
mixing the crystalline polyester resin particles, the non-crystalline polyester resin particles, a wax dispersion liquid, and a colorant dispersion liquid to prepare a dispersion liquid containing aggregated particles;
fusing the aggregated particles into toner particles; and
washing the toner particles.

8. The toner according to claim 7, further comprising:
carrying out annealing at the temperature lower than the temperature of the endothermic peak of the crystalline polyester resin by 5° C. to 15° C., before, during, or after the washing.

9. A developer, comprising:
a toner,
wherein the toner contains;
a crystalline polyester resin; and
a non-crystalline polyester resin,
wherein the crystalline polyester resin has a melting point of 60° C. to 80° C., and
wherein the toner satisfies the relationship represented by the following formula:
(W1−W1′)/W1<0.50
where W1 is a temperature width at a 1/3 height of a height of an endothermic peak of the crystalline polyester resin on a differential scanning calorimetry curve of the toner at the time of an initial temperature elevation as measured by differential scanning calorimetry, and W1′ is a temperature width at a 1/3 height of a height of an endothermic peak of the crystalline polyester resin on a differential scanning calorimetry curve of the toner measured after the toner has been heated at 50° C. for 24 hours.

10. An image forming method comprising:
forming a latent electrostatic image on a latent electrostatic image bearing member;
developing the latent electrostatic image with a toner to form a visible image;
transferring the visible image to a recording medium; and
fixing the visible image transferred to the recording medium thereon,
wherein the toner contains:
a crystalline polyester resin; and
a non-crystalline polyester resin,
wherein the crystalline polyester resin has a melting point of 60° C. to 80° C., and
wherein the toner satisfies the relationship represented by the following formula:
(W1−W1′)/W1<0.50
where W1 is a temperature width at a 1/3 height of a height of an endothermic peak of the crystalline polyester resin on a differential scanning calorimetry curve of the toner at the time of an initial temperature elevation as measured by differential scanning calorimetry, and W1′ is a temperature width at a 1/3 height of a height of an endothermic peak of the crystalline polyester resin on a differential scanning calorimetry curve of the toner measured after the toner has been heated at 50° C. for 24 hours.
